(19) United States
(12) Patent Application Publication
(10) Pub. No.: US 2011/0222676 A1
(43) Pub. Date: Sep. 15, 2011

(54) IMAGE DISPLAY APPARATUS, TELECONFERENCING DEVICE, AND IMAGE DISPLAY METHOD

(75) Inventors: Susumu Okada, Kanagawa (JP); Yoshito Nakanishi, Osaka (JP)

(73) Assignee: PANASONIC CORPORATION, Osaka (JP)

(21) Appl. No.: 13/129,878

(22) PCT Filed: Nov. 19, 2009
(86) PCT No.: PCT/JP2009/006255

§ 371 Date: May 18, 2011

(30) Foreign Application Priority Data
Nov. 20, 2008 (JP) 2008-296986
Dec. 12, 2008 (JP) 2008-316742
Jan. 8, 2009 (JP) 2009-002878

(51) Int. Cl. H04M 11/00; G09G 5/00

(52) U.S. Cl. 379/93.21; 345/204

(57) ABSTRACT

A purpose of the invention is to provide an image display apparatus capable of allowing a user at its own location to recognize a position of a subsidiary display region on a display screen at a counterpart location. The image display apparatus can configure a plurality of display regions on the display screen. The image display apparatus receives, via a network 120, content display region information for configuring a plurality of display regions 201 and 202 on a display 140 of another image display apparatus, and provides the position of the subsidiary display region 202 in the plurality of display regions 201 and 202 in the another display apparatus based on the received content display region information.

### TECHNICAL FIELD

The present invention relates to an image display apparatus, a teleconferencing device, and an image display method. Particularly, the invention relates to a teleconferencing device that performs communication between persons at remote locations by mutually transmitting or receiving video pictures captured by cameras and displaying them, and an image display apparatus capable of displaying a configuration of a counterpart screen.

### BACKGROUND ART

A teleconferencing device transmits or receives video pictures or the like captured by a camera or audio via a network so as to achieve communication with video pictures to a person at a remote location. FIG. 15 is a conception view showing a state in which two parties geographically separated from each other are carrying out a remote communication by respectively using teleconferencing devices. As shown in FIG. 15, teleconferencing devices 10A and 10B, cameras 11A and 11B are respectively provided at geographically remote locations A and B. The teleconferencing devices 10A and 10B are connected to each other via a network 13. A video picture of the location A captured by the camera 11A is transmitted from the teleconferencing device 10A to the teleconferencing device 10B via the network 13 and is displayed thereon. Similarly, a video picture of the location 10B captured by the cameral 11B is transmitted from the teleconferencing device 10B to the teleconferencing device 10A via the network 13 and is displayed thereon.

In the recent years, as infrastructures of IP networks have been developed, teleconferencing devices that transmit video picture data of a cameral or audio data to a remote location so as to display the data via IP networks have been installed at various locations.

In a case where teleconferencing devices are provided at various locations and a video conference system configured by a plurality of teleconferencing devices is used, a video conference can be held by displaying an image of a counterpart location on a display screen of each of the teleconferencing devices. In a case where a user of any of the teleconferencing devices would like to grasp whether or not an image of the user itself is captured by a camera, an image of the user's own location can be displayed on the teleconferencing device of the own location together with an image of the counterpart location by being superposed on the image of the counterpart location.

For example, as shown in FIG. 20, a video conference is held by using a teleconferencing device at a location A and a teleconferencing device at a location B. In the teleconferencing device shown in FIG. 20, an image (an own image) 1502 of the location A can be displayed on a part of an image (a counterpart image) 1501 of the location B which is displayed on a screen 1500 at the location A by being superposed thereon, so that a user can grasp whether or not the user itself is captured by a camera.

Similarly to the above, as shown in FIG. 28, a video conference is held by using a teleconferencing device at a location A and a teleconferencing device at a location B. As shown in FIG. 28(a), an image (an own image) 2012 of the location A can be displayed on a part of an image (a counterpart image) 2011 of the location B which is displayed on a screen 2010 at the location A by being superposed thereon, so that a user can grasp whether or not the user itself is captured by a camera.

In such a method of displaying in a superposing manner, a screen display method is known, as an example, that is configured to display video picture data of a camera of an own location in a small size, as a child screen, on a counterpart screen displayed in a large size (for example, see patent document 2). The child screen can be displayed at a position desired by a user in such a manner that the screen displayed in the small size is moved by an input device such as a mouse or the like.

### PRIOR ART DOCUMENTS

### Patent Documents

Patent Document 1: JP-A-2006-106388
Patent Document 2: JP-A-2004-101708

### SUMMARY OF INVENTION

### Problems that the Invention is to Solve

Some of teleconferencing devices, have a function of superposing a function setting screen by means of a GUI, or an image content or the like acquired from an external device on a video picture transmitted from another teleconferencing device and displaying the superposed image. In the example shown in FIG. 15, a GUI screen 21 is displayed at an upper right portion of a screen of the teleconferencing device 10B by being superposed on a video picture transmitted from the teleconferencing device 10A. At that time, an image of a person 31 on the observers' right in two persons in a location A is almost hidden by the GUI screen 21 in the screen of the teleconferencing device 10B. However, information relating to the above display state is not transmitted to the teleconferencing device 10A. Therefore, there is no way for the persons at the location A to know a portion that is not displayed on the screen of the teleconferencing device 10B in the video picture which is captured by the camera 11A and is transmitted to the teleconferencing device 10B or to know the above fact.

The patent document 1 discloses a capture range projection/display apparatus that projects and displays, in a direction of an object, light beams which have a frame-like shape surrounding a predetermined region and cover the inner portion of the frame in order to suggest a capturing range of a capturing device. In a case where the capture range projection/display apparatus is applied to the example shown in FIG. 15, the capture range projection/display apparatus projects and displays the light beams to the persons at the location A, the beams indicating a range displayed on the screen of the teleconferencing device 10B. However, the projected light beams do not indicate a region indicating the GUI screen 21 in the screen of the teleconferencing device 10B.

In a method disclosed by the patent document 2, although it is possible to grasp what type of video picture data is displayed on a display screen of its own location, it is not possible to grasp what type of video picture data is displayed on a display screen of a counterpart location. As a result, video picture data, that a user would like to show to a counterpart person in the video picture data of the own location on the display screen at the counterpart location, is hidden by a child screen which is displayed on the display screen at the counterpart location by being superposed thereon so that a conference is sometimes not progressed smoothly.

For example, at the location A shown in FIG. 20(a), an image 1502 of the own location is displayed in the small size at the lower right portion of the counterpart image 1501 so that a user can recognize that the own location is captured by the camera. However, at the location B shown in FIG. 20(b), a part of an image of a portion around a face of a participant 1511 of the conference at the own location is hidden by a child screen 1513 indicating the image of the counterpart location. Thus, in a practical sense, there is a case where desired video picture data is not displayed on the counterpart screen.

In FIG. 20(b) shows an example in which while the participants 1511 and 1512 of the conference at the own location are captured by the camera at the own location, video picture data of the participant 1511 of the conference is not displayed on the counterpart screen (the display screen at the location A) by the child screen 1513. Such an example is not limited to the participants themselves of the conference, but can similarly correspond to materials that a participant of the conference would like to show to participant(s) at the counterpart location, or video picture data of materials or the like to be shared in the conference between the own location and the counterpart location.

Similarly to the above, at the location A shown in FIG. 28(a), the image 2012 of the own location is displayed in the counterpart image 2011 in a small size at a lower right portion thereof so that it is possible to recognize the image captured by the camera. However, at the location B shown in FIG. 28(b), a part of an image of a portion around a face of a participant 2021 of the conference at the own location is hidden by a child screen 2023 indicating the image of the counterpart location. Thus, in a practical sense, there is a case where desired video picture data is not displayed on the counterpart screen.

In FIG. 28(b), shows an example in which at the location B, even when the participants 2021 and 2022 of the conference at the own location are captured by the camera at the own location, a video picture of the participant 2021 of the conference is not displayed on the counterpart screen by the child screen 2023 which is displayed on the display screen by being superposed thereon. Such hiding example is not limited to the participants themselves of the conference, but can similarly be applied to materials that a participant of the conference would like to show to participant(s) at the counterpart location, or a video picture of materials or the like to be shared in the conference between the own location and the counterpart location.

In view of the above circumstances, a purpose of the invention is to provide an image display apparatus capable of allowing a user at its own location to recognize a position of a subsidiary display region of a display screen at a counterpart location.

Particularly, a purpose of the invention is to provide a teleconferencing device which is so configured that an actual display region in captured video pictures to be displayed on a display screen of a teleconferencing device which receives video pictures captured by a camera, can be provided to a user of the teleconferencing device which transmits the captured video pictures, and to provide an image display method thereof. In addition, a purpose of the invention is to provide an image display apparatus, a teleconferencing device and an image display method each capable of allowing a user to grasp what type of content is displayed on a display screen at a counterpart location. Further, a purpose of the invention is to provide an image display apparatus, a teleconferencing device and an image display method each capable of preventing a child screen from being overlapped with a predetermined object image on a display screen at a counterpart location.

### Means for Solving the Problems

An image display apparatus according to the invention that can configure a plurality of display regions on a display screen, includes a reception section that receives, through a communication line, another screen configuration information for configuring a plurality of display regions on a display screen of another image display apparatus, and a control section that controls to provide a position of a subsidiary display region in the plurality of display regions in the another image display apparatus on the basis of the received another screen configuration information.

In accordance with the above configuration, it is possible to allow a user at its own location to recognize the position of the subsidiary display region on the display screen at a counterpart location.

In addition, a teleconferencing device according to the invention that is used in a video conference system which mutually transmits or receives video pictures captured by cameras, includes a capture region acquisition section that acquires capture region information relating to a capture region of a camera of the teleconferencing device, an information acquisition section that acquires content display region information relating to a display region of a content displayed on a display screen of another teleconferencing device which receives the video picture of the camera transmitted from the teleconferencing device, an actual display region determination section that determines an actual display region in which the captured video picture is displayed on the display screen of the another teleconferencing device on the basis of the capture region information and the content display region information, and a control section that controls a providing device which provides, to a user of the teleconferencing device, the actual display region in the capture region of the camera on the basis of the actual display region determined by the actual display region determination section.

Further, an image display apparatus according to the invention that configures a plurality of display regions on a display screen, includes a layout reception section that receives another screen configuration information for configuring a plurality of display regions on a display screen of another image display apparatus, an own screen configuration setting section that sets own screen configuration information for configuring a display region on a display screen of the image display apparatus, a layout determination section that determines a position of a reproduction region having a plurality of reproduction display regions which correspond to the plurality of display regions on the display screen of the another image display apparatus, on the display screen of the image display apparatus on the basis of the own screen configuration information and the another screen configuration information, and a display section that displays, in the reproduction display regions respectively in the reproduction region determined by the layout determination section, respective display data to be displayed in the display regions respectively on the display screen of the another image display apparatus.

In accordance with the above configuration, it is possible to grasp what type of content is displayed on the display screen at a counterpart location. To be specific, the screen configuration information for configuring the display screen at the counterpart location is acquired, the screen configuration for configuring the display screen at the own location is set, and then the display screen of the counterpart location is reproduced on the display screen at the own location. By confirming the reproduction display, it is possible to grasp a display mode at the counterpart location.

Moreover, an image display apparatus that can configure a plurality of display regions on a display screen according to the invention, includes a capture section that captures an object image of an own location where the image display apparatus is placed, an object image detection section that detects the object image included in video picture data obtained by capturing the capture section, a layout reception section that receives, through a communication line, another screen configuration information for configuring a plurality of display regions on another display screen as a display screen of the another image display apparatus, a determination section that determines whether or not the object image included in the video picture data is overlapped with a subsidiary display region which is formed in a main display region in a superposing manner, on the basis of the another screen configuration information and a detection position of the object image, in a case where the video picture data is displayed in the main display region on the another display screen, and a capturing state control section that controls a capturing state of the capture section based on a determination result of the determination section.

In accordance with the above configuration, it is possible to prevent a child screen from being overlapped with a predetermined object image on a display screen at a counterpart location. To be specific, the screen configuration information for configuring the display screen at the counterpart location is acquired, and the object image included in the video picture data of the own location is detected. Next, it is determined whether or not the object image is overlapped with the child screen as a subsidiary display region of the display screen at the counterpart location on the basis of the screen configuration information and the detection position of the object image. By virtue of the determination, even in a case where there is, for example, important display data which is hidden by the child screen on the display screen at the counterpart location, the capturing state of the capture unit at the own location can be changed so that it is possible to make a state that the display data is not hidden by the child screen.

### Advantage of the Invention

In accordance with the invention, it is possible to allow a user at its own location to recognize a position of a subsidiary display region on a display screen at a counterpart location.

In addition, in accordance with the invention, an actually displayed region in capture video pictures captured by a camera to be displayed on a display screen of a teleconferencing device which receives the capture video pictures can be provided to a user of a teleconferencing device which transmits the capture video pictures.

Further, in accordance with the invention, it is possible to grasp what type of content is displayed on the display screen at the counterpart location. For example, it is possible to intuitively understand what type of screen configuration the display screen of the teleconferencing device at the counterpart location uses and whether or not a material such as a face of the user itself that the user would like to show to the counterpart participant is displayed on the display screen.

Moreover, in accordance with the invention, it is possible to prevent a child screen from being overlapped with a predetermined object image on the display screen at the counterpart location.

### BRIEF DESCRIPTION OF THE DRAWINGS

FIG. 1 is a block diagram showing a structure of a video conference system according to a first embodiment of the invention.

FIG. 2 is a schematic view typically showing a positional relationship between a video picture 201 which is captured by a camera 100 and is displayed on a display 140 and a content 202 displayed on the video picture 201 according to the first embodiment of the invention.

FIG. 3 is a schematic view typically showing a positional relationship between a video picture 201 which is captured by the camera 100 and is displayed on the display 140 and the content 202 displayed on the video picture 201 according to the first embodiment of the invention.

FIG. 4 is a schematic view showing a structure of a light projection device 150 according to the first embodiment of the invention.

FIG. 5 is a schematic view having a top view (a) and a sectional view (b) taken along line A-A of a two-dimensional scan mirror 300 according to the first embodiment of the invention.

FIG. 6 is a schematic view having a sectional view (a) taken along a axis line and a sectional view (b) taken along β axis line of the two-dimensional scan mirror 300 shown in FIG. 5.

FIG. 7 is a schematic view showing a relationship between electrostatic forces Fon and Foff and a spring force kZ at a swing face in the first embodiment of the invention.

FIG. 8 is a graph showing a relationship between the electrostatic force Fon and the spring force kZ depending on a displacement amount of a swing face 601 according to the first embodiment of the invention.

FIG. 9 is a graph showing a relationship between a control voltage and a swing angle of the swing face according to the first embodiment of the invention.

FIG. 10 is a schematic view showing a time base relationship between each of video picture frames at a time when the camera 100 performs capturing and a timing when the light projection device 150 projects light according to the first embodiment of the invention.

FIG. 11 is a flowchart showing an operation of the video conference system according to the first embodiment of the invention.

FIG. 12 is a schematic view showing an example of the video conference system according to the first embodiment of the invention.

FIG. 13 is a schematic view showing an example of the video conference system according to the first embodiment of the invention.

FIG. 14 is a schematic view showing an example of the video conference system according to the first embodiment of the invention.

FIG. 15 is a conception view showing a state in which two parties geographically separated from each other are performing remote communication by using respective teleconferencing devices.

FIGS. 16(a) to 16(c) are schematic views respectively showing an example of video picture data displayed on a display screen of a teleconferencing device according to a second embodiment of the invention.

FIG. 17 is a block diagram showing an example of a structure of the teleconferencing device according to the second embodiment of the invention.

FIGS. 18(a) to 18(e) are typical views respectively showing a screen configuration of the teleconferencing device according to the second embodiment of the invention.

FIG. 19 is a flowchart showing an example of an operation at a time when a layout determination section determines a screen configuration in the teleconferencing device according to the second embodiment of the invention.

FIGS. 20(a) and 20(b) are schematic views respectively showing video picture data displayed on a display screen of a related teleconferencing device.

FIG. 21 is a block diagram showing an example of a structure of a teleconferencing device according to a third embodiment of the invention.

FIG. 22 is a typical view showing an example of a screen configuration of the teleconferencing device according to the third embodiment of the invention.

FIG. 23 is a flowchart showing an example of a main operation of a determination section of the teleconferencing device according to the third embodiment of the invention.

FIG. 24 is a schematic view showing an example of a positional relationship between a child screen and a face region in a case where video picture data captured by a camera at an own location is displayed on a display screen at a counterpart location according to the third embodiment of the invention.

FIG. 25 is a schematic view showing an example of a positional relationship between the child screen and the face region in a case where the video picture data captured by the camera at the own location is displayed on the display screen at the counterpart location according to the third embodiment of the invention.

FIG. 26 is a schematic view showing an example of a positional relationship between the child screen and the face region in a case where the video picture data captured by the camera at the own location is displayed on the display screen at the counterpart location according to the third embodiment of the invention.

FIG. 27 is a schematic view showing an example of a positional relationship between the child screen and the face region in a case where the video picture data captured by the camera at the own location is displayed on the display screen at the counterpart location according to the third embodiment of the invention.

FIGS. 28(a) and 28(b) are schematic views each showing an example of a video picture displayed on a display screen of a teleconferencing device.

### MODE FOR CARRYING OUT THE INVENTION

Embodiments of the invention are described below with reference to the drawings. Various symbols (X, Y, L, ω, θ, N, x1, y1, etc.) are independently used in each of the embodiments.

### First Embodiment

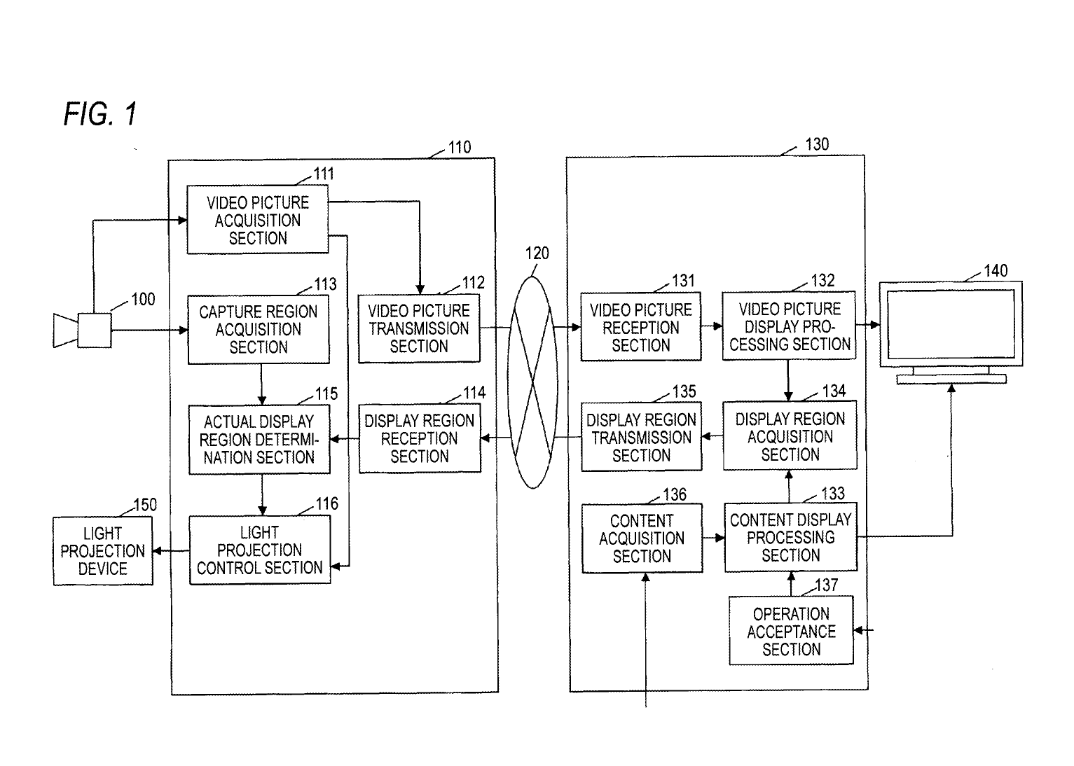

FIG. 1 is a block diagram showing a structure of a video conference system of the embodiment. The video conference system shown in FIG. 1 includes a camera 100 for capturing a person, a video picture transmission device 110, a light projection device 150, a network 120, a video picture reception device 130 and a display 140. The video conference system is an example of an image display apparatus.

In the structure of the video conference system shown in FIG. 1, a video picture transmission device 110 transmits a video picture captured by the camera 100 to the video picture reception device 130 via the network 120 and the display 140 displays the transmitted video picture. Therefore, a flow of a video picture signal is in only one way from the video picture transmission device 110 to the video picture reception device 130. However, in the video conference system of the embodiment, a structure similar to that of the video picture transmission device 110 is provided at the video picture reception device 130 side and a structure similar to that of the video picture reception device 130 is provided at the video picture transmission device 110 side so that bi-directional communication of the video picture signals can be performed.

The video picture transmission device 110 has a video picture acquisition section 111, a video picture transmission section 112, a capture region acquisition section 113, a display region reception section 114, an actual display region determination section 115, and a light projection control section 116. The video picture acquisition section 111 acquires the video picture captured by the camera 100. The video picture acquisition section 111 transmits a synchronous signal of the camera 100 to the light projection control section 116. The video picture transmission section 112 transmits a video picture acquired by the video picture acquisition section 111 to the video picture reception device 130 via the network 120.

The capture region acquisition section 113 acquires information relating to a capture region of the camera 100 (hereinafter, referred to as “the capture region information”) and transmits the capture region information to the actual display region determination section 115. The capture region information includes rotational angles of the camera 100 in the horizontal and vertical directions in a coordinate system in which the front face direction of the camera 100 is made to 0 degree, a field angle and a distance from the plain face indicative of the capture region of the camera 100 to the camera 100. The capture region acquisition section 113 can acquire the number of pixels in each of the vertical and horizontal directions of the video picture captured by the camera 100 and can input them to the capture region information. In a case where the camera 100 can be zoomed, the capture region acquisition section 113 can transmit the capture region information to the actual display region determination section 115 when zooming is completed.

The display region reception section 114 receives information relating to a display region of a content (hereinafter, referred to as “the content display region information”) displayed on the display 140 transmitted from the video picture reception device 130. Meanwhile, the content can be a function setting screen by a GUI of the video picture reception device 130, a video picture captured by a camera (not shown) provided in the video picture reception device 130, and a video picture, an image or the like stored in the video picture reception device 130. Also, the content can be a video picture, an image or the like transmitted from an external device connected to the video picture reception device 130. In the embodiment, the display screen of the content to be displayed on the display 140 is in a rectangular shape. The content display region information includes information relating to the number of pixels in each of the vertical and horizontal directions of the video picture to be displayed on the display and position information indicated by, for example, positions of an upper left apex and a lower right apex of a content in a two-dimensional coordinate of the video picture. Meanwhile, the content display region information is an example of another screen configuration information.

The actual display region determination section 115 determines a region in which a video picture is displayed on the display 140 based on the capture region information acquired by the capture region acquisition section 113 and the content display region information received by the display region reception section 114. Meanwhile, a region displayed on the display 140 is referred to as “the actual display region”, hereinafter. The detail of a determination method of the actual display region by the actual display region determination section 115 will be described later.

The light projection control section 116 controls the light projection device 150 based on information relating to the actual display region determined by the actual display region determination section 115 and the synchronous signal of the camera 100 transmitted from the video picture acquisition section 111. The detail of the light projection device 150 will be described later.

The video picture reception device 130 includes a video picture reception section 131, a video picture display processing section 132, a content acquisition section 136, a content display processing section 133, a display region acquisition section 134, a display region transmission section 135, and an operation acceptance section 137. The video picture reception section 131 receives a video picture transmitted from the video picture transmission device 110 via the network 120. The video picture display processing section 132 processes to display the video picture received by the video picture reception section 131 on the display 140. The video picture display processing section 132 transmits, to the display region acquisition section 134, information relating to the number of pixels in each of the vertical and horizontal directions of the video picture to be displayed on the display 140.

The content acquisition section 136 acquires a content recorded in a recording medium (not shown) provided in the video picture reception device 130 and a content transmitted from an external device (not shown) connected to the video picture reception device 130. The content acquisition section 136 can also acquire a content from a server or the like connected thereto via the network 120. The content display processing section 133 processes to display the contents acquired by the content acquisition section 136 on the display 140. The content display processing section 133 transmits, to the display region acquisition section 134, the position information of a content in a rectangular shape which is indicated by positions of an upper left apex and a lower right apex of the content in the two-dimensional coordinate of the video picture displayed on the display 140.

The display region acquisition section 134 acquires, from the video picture display processing section 132, information relating to the number of pixels in each of the vertical and horizontal directions of the video picture to be displayed on the display 140. In addition, the display region acquisition section 134 acquires, from the content display processing section 133, the position information of the content which is superposed on the video picture and is displayed on the display 140. The display region acquisition section 134 transmits the information as content display region information to the display region transmission section 135.

The display region transmission section 135 transmits the content display region information transmitted from the display region acquisition section 134 to the video picture transmission device 110 via the network 120. The operation acceptance section 137 accepts an operation of designating a content to be displayed on the display 140, or a size or a position of the content. The operation acceptance section 137 applies the designation according to the accepted operation to the content display processing section 133.

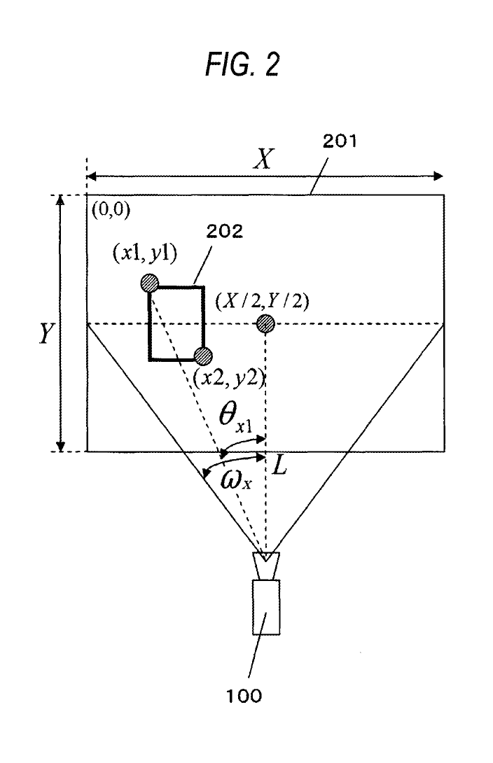

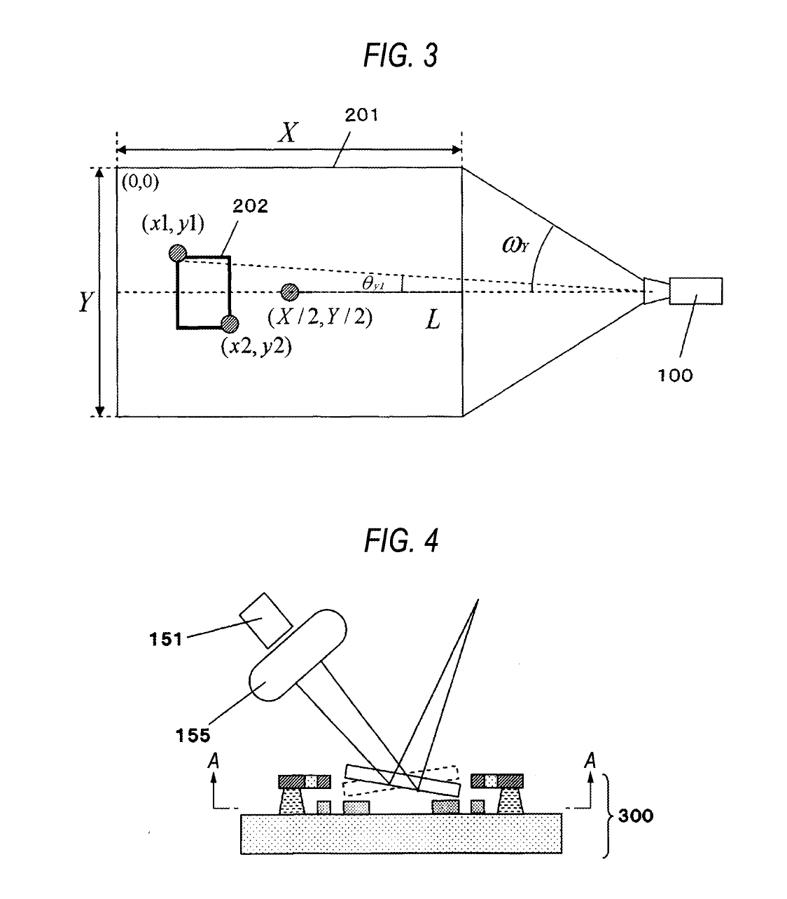

A process of determining an actual display region where a video picture captured by the camera 100 is displayed on the display 140 in the actual display region determination section 115 of the video picture transmission device 110 is described below in detail with reference to FIGS. 2 and 3. Each of FIGS. 2 and 3 is a schematic view typically showing a positional relationship between a video picture 201 which is captured by the camera 100 and is displayed on the display 140 and a content 202 displayed on the video picture 201. Meanwhile, the positional relationship among the video picture 201, the content 202 and the camera 100 shown in FIG. 2 is formed when the camera 100 is viewed from the above. The positional relationship among the video picture 201, the content 202 and the camera 100 shown in FIG. 3 is formed when the camera 100 is viewed from the side. The screen region of the content 202 is an example of a subsidiary display region.

The positional relationship between the video picture 201 and the content 202 is shown in FIGS. 2 and 3 and is described below. The two-dimensional coordinate of the video picture 201 is represented by the numbers of pixels in the vertical and horizontal axes by making an upper left apex of the video picture 201 as an origin and the pixel as a unit of each of the axes. In the example shown in FIGS. 2 and 3, the number of pixels in the horizontal direction of the video picture 201 is X and the number of pixels in the vertical direction is Y. The content display processing section 133 transmits, to the display region acquisition section 134, the position information indicating positions of the upper left apex (x1, y1) and lower right apex (x2, y2) of the content 202 on the two-dimensional coordinate. On the other hand, the video picture display processing section 132 transmits, to the display region acquisition section 134, information (X, Y) relating to the number of pixels in each of the vertical and horizontal directions of the video picture 201.

In a case where a plurality of contents are superposed on the video picture, the content display processing section 133 applies an identification number to each of the contents. The position information of each of the contents includes information indicative of the identification number. For example, in a case where two contents are superposed on a video picture, the position information of the first content is represented by (1, x1, y1) and (1, x2, y2). Also, the position information of the second content is represented by (2, x1′, y1′) and (2, x2′, y2′).

In a case where there are a plurality of displays 140, the content display processing section 133 applies a display identification number to a content. In a case where, for example, there are three displays A, B and C, the content display processing section 133 causes the above described first content to be displayed on the display A and causes the second content to be displayed on the display C. In this case, the position information of the first content is represented by (1, A, x1, y1) and (1, A, x2, y2). Also, the position information of the second content is represented by (2, C, x1′, y1′) and (2, C, x2′, y2′).

Next, the positional relationship among the video picture 201, the content 202 and the camera 100 is described below. As shown in FIGS. 2 and 3, an example having one content and one display 140 is described below. The actual display region determination section 115 of the video picture transmission device 110 converts the position information of the content 202 into angle information with reference to a placement position and a capturing direction of the camera 100.

An angle ωX indicated in FIG. 2 is an angle obtained such that the field angle in the horizontal direction of the camera 100 is bisected in the capturing direction of the camera 100. An angle θx1 in the FIG. 2 is an angle of the upper left apex (x1, y1) of the content 202 in the video picture 201 in the horizontal direction with respect to the capturing direction of the camera 100.

An angle ωY indicated in FIG. 3 is an angle obtained such that the field angle in the vertical direction of the camera 100 is bisected in the capturing direction of the camera 100. An angle θy1 in the FIG. 3 is an angle of the upper left apex (x1, y1) of the content 202 in the video picture 201 in the vertical direction with respect to the capturing direction of the camera 100.

The actual display region determination section 115 calculates out the angle θx1 shown in FIG. 2 and the angle θy1 shown in FIG. 3 based on the capture region information obtained from the capture region acquisition section 113 and the content display region information received by the display region reception section 114 by using the following formula. Meanwhile, a parameter L in the formula is a distance from a plane indicative of the capture region of the camera 100 to the camera 100.

The angle ωX and the angle θx1 shown in FIG. 2 are determined by the following formulas (1) and (2).

$$\begin{matrix}Mathematical formula 1 & \\ tan {θ}_{x 1} = \frac{X / 2 - x 1}{L} & ( 1 ) \\ Mathematical formula 2 & \\ tan {ω}_{X} = \frac{X / 2}{L} & ( 2 )\end{matrix}$$

The angle θx1 is represented by the formula (3) based on the formulas (1) and (2).

$$\begin{matrix}Mathematical formula 3 & \\ {θ}_{x 1} = {tan}^{- 1} \frac{tan {ω}_{X} ( X / 2 - x 1 )}{X / 2} & ( 3 )\end{matrix}$$

Similarly, the angle θy1 is represented by the formula (4).

$$\begin{matrix}Mathematical formula 4 & \\ {θ}_{y 1} = {tan}^{- 1} \frac{tan {ω}_{Y} ( Y / 2 - y 1 )}{Y / 2} & ( 4 )\end{matrix}$$

Thus, the region of the content 202 in the video picture 201 captured by the camera 100 is represented by an angle with reference to the placement position and the capturing direction of the camera 100. The actual display region determination section 115 determines a region obtained by removing the region of the content 202 from the video picture 201 to be the actual display region displayed on the display 140.

Next, the light projection device 150 is described below with reference to FIGS. 4 to 6. The light projection device 150 provides the region of the video picture which is captured by the camera 100 and is displayed on the display 140 to a user of the video picture transmission device 110 by means of light.

FIG. 4 is a schematic view showing a structure of the light projection device 150. As shown in FIG. 4, the light projection device 150 includes a two-dimensional scan mirror 300 that can be displaced in two axes perpendicular to each other, a light source 151 that emits light to a mirror section 309 of the two-dimensional scan mirror 300, and a collimator lens 155.

The light source 151 emits coherent light and is formed of, for example, an LED for emitting red color light. In this case, for example, the light projection device 150 projects the red color light to a region displayed on the display 140. The collimator lens 155 is provided between the light source 151 and the two-dimensional scan mirror 300 and prevents diffusion of the light.

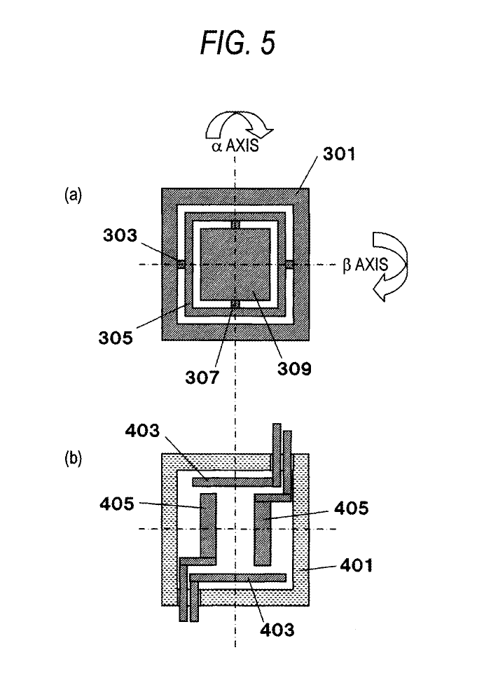

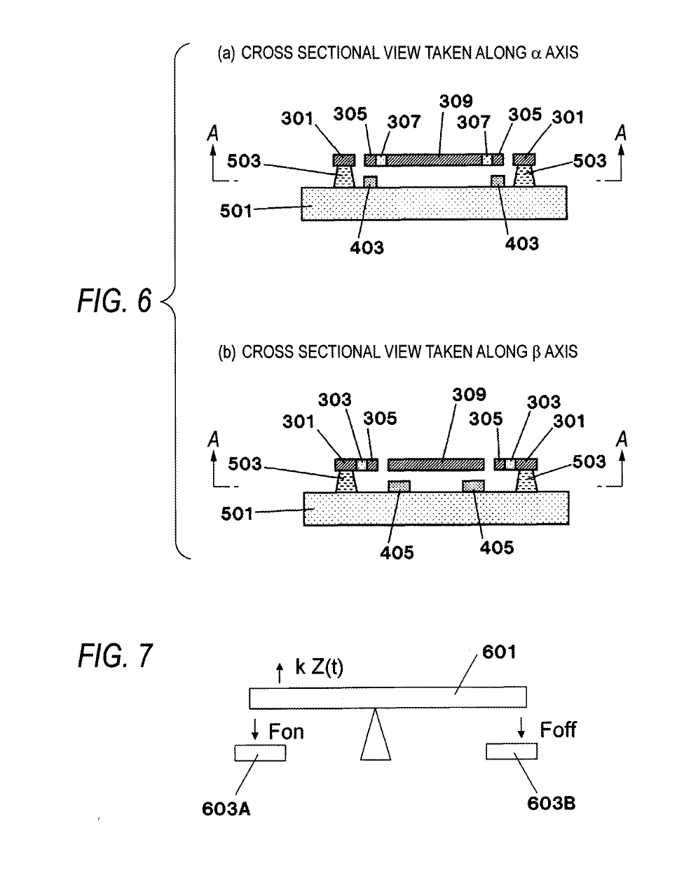

FIG. 5 is a schematic view having a top view (a) and a sectional view (b) taken along line A-A of the two-dimensional scan mirror 300. FIG. 6 is a schematic view having a sectional view (a) taken along a axis line and a sectional view (b) taken along β axis line of the two-dimensional scan mirror 300 shown in FIG. 5. The two-dimensional scan mirror 300 includes a substrate 501, a post section 401, a β axis excitation electrode 403, an α axis excitation electrode 405, a fixing frame 301, a β axis coupling section 303, a β axis swinging face 305, an α axis coupling section 307, and the mirror section 309 swingable in two axes (an α axis and a β axis). The mirror section 309 is formed of a metal or silicon that reflects light.

As shown in FIGS. 5(b) and 6, a square shaped post section 401 (503 in FIG. 6) is provided on the substrate 501. A square shaped fixing frame 301 is supported on the post section 401. The β axis swinging face 305 is connected to the fixing frame 301 with the β axis coupling section 303 therebetween. The β axis swinging face 305 can swing centering around the β axis coupling section 303 with respect to the fixing frame 301. The mirror section 309 is connected to the β axis swinging face 305 with the α axis coupling section 307 therebetween. The mirror section 309 can swing centering around the α axis coupling section 307 with respect to the β axis swinging face 305. Therefore, the mirror section 309 can be displaced centering around the α axis and the β axis, independently. That is, the mirror section 309 can be displaced in an arbitrary two-dimensional direction.

Two α axis excitation electrodes 405 are provided on the substrate 501 just below the mirror section 309 to be positioned symmetrically on the right and left sides of the α axis. Tow β axis excitation electrodes 403 are provided on the substrate 501 just below the β axis swinging face 305 to be positioned symmetrically on the right and left sides of the β axis.

In the two-dimensional scan mirror 300, when a control signal transmitted from the light projection control section 116 of the video picture transmission device 110 is supplied to each of the excitation electrodes, the mirror section 309 is displaced with respect to the α axis and the β axis swinging face 305 is displaced with respect to the β axis. A relationship between the control signal and a swinging angle is described below with reference to FIG. 7. FIG. 7 is a schematic view showing a relationship between electrostatic forces Fon and Foff and a spring force kZ on the swinging face.

As shown in FIG. 7, in forces acting on the swinging face 601, there are the electrostatic forces Fon and Foff applied from excitation electrodes 603A and 603B respectively provided just below the both ends of the swinging face 601 and the spring force kZ on the swinging face 601. A dynamic equation about the swinging face 601 is described below. In the equation, “m” represents a mass of the mirror, “b” represents a dumping coefficient, “Z(t)” represents a displacement amount at a time t, “g” represents a gap between the excitation electrodes 603A and 603B and the swinging face 601, and “k” represents a spring constant.

$$Mathematical formula 5$$

$$m \frac{d}{d {t}^{2}} {Z ( t )}^{2} + {b ( L 2 - \frac{Z ( t )}{g} )}^{- \frac{3}{2}} \frac{d}{d t} Z ( t ) + kZ ( t ) = {F}_{ON} - {F}_{OFF}$$

The electrostatic force Fon applied from the excitation electrodes 603A is computed by the following formula. In the formula, “ε0” represents a permittivity, “w” represents a width of the mirror, “g0” represents an initial gap between the swinging face 601 and the excitation electrode 603A, “td” represents a thickness of a dielectric material provided on the surface of the mirror, “εr” represents a relative permittivity of the dielectric material, and “Z” represents a displacement amount.

$$Mathematical formula 6$$

$${F}_{ON} = \frac{1}{2} \frac{ɛ {Ow}^{2} {V}^{2}}{{( g + td / ɛ r - Z )}^{2}} ;$$

Regarding the force acting on the swinging face 601, when the control signal is supplied to the excitation electrode 603A, a downward force (the electrostatic force Fon) is applied to the left side of the swinging face 601. Thus, when the swinging face 601 is displaced, a force for restoring the swinging face 601 to its original state, i.e., the spring force kZ acts upward. Since the spring force kZ is represented by a product of the displacement amount Z and the spring constant k, the more the displacement amount Z is increased, the more the spring force kZ is increased. As a result, the restoring force applied to the swinging face 601 is increased.

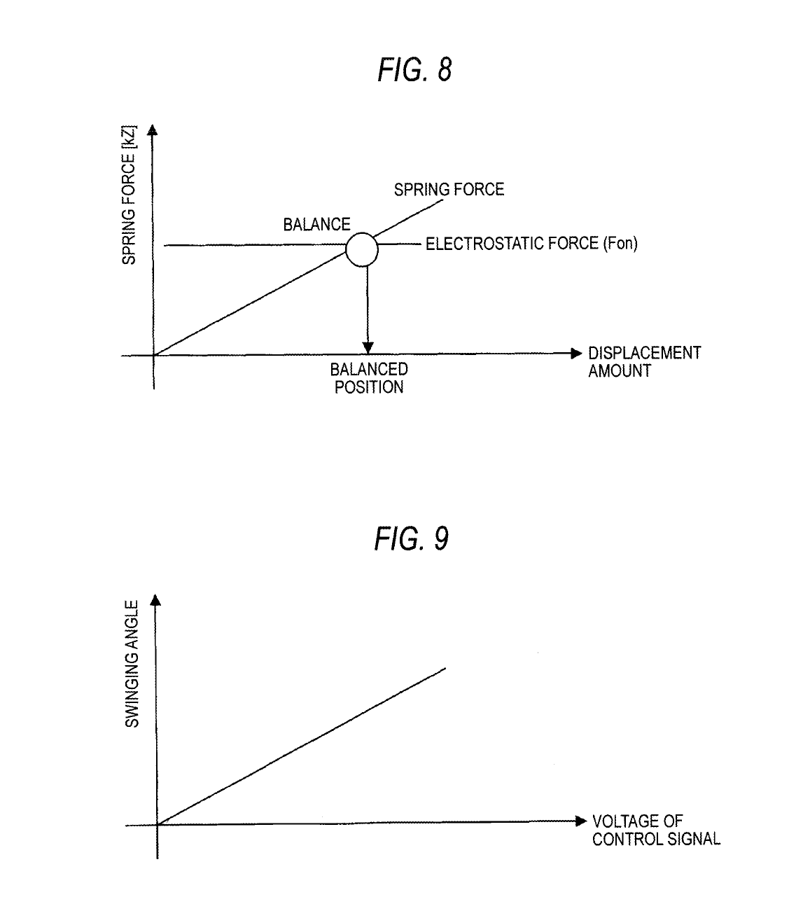

Consequently, regarding the force acting on the swinging face 601, in a case where a constant voltage is applied to the excitation electrode 603A, a constant electrostatic force Fon is applied to the swinging face 601. The electrostatic force Fon causes the swinging face 601 to be displaced toward the excitation electrode 603A, and at the same time, the spring force kZ is increased in accordance with the displacement amount. As shown in FIG. 8, swinging face 601 is balanced at a position where the spring force kZ is equal to the electrostatic force Fon, and the swinging face 601 stops in that state.

Meanwhile, the electrostatic force is in proportion to a minus square of the gap between the swinging face and the excitation electrode, and the spring force is in proportion to the displacement amount. With this, when the gap exceeds a predetermined position, a balance point becomes instable so that a so-called pull-in phenomenon that the excitation electrode is pulled, occurs. Therefore, the displacement amount of the swinging face is controlled in such a manner that at least the gap between the excitation electrode and the swinging face is displaced within a degree of one-third of the initial gap.

Thus, the voltage of the control signal supplied to the excitation electrode and the position of the swinging face are in a one-on-one relationship. Therefore, regarding the swinging face, when the voltage of the control signal is determined, the position of the swinging face can be controlled. FIG. 9 is a graph showing a relationship between the control voltage and a swing angle of the swinging face. When the swinging face is used at a region in which the swing angle of the swinging face is linearly displaced with respect to the voltage of the control signal, the swing angle of the swinging face with respect to the voltage of the control signal is uniquely determined. That is, in order to displace the swinging face to be in a predetermined angle, it is enough to supply the control signal having a predetermined voltage to the excitation electrode.

For example, in order to displace the swinging face to a substrate 501 side centering around the α axis, a predetermined control signal is supplied only to the α axis excitation electrode 405 shown at the right hand in FIG. 5, so that the right side of the mirror section 309 is displaced to the substrate 501 side centering around the α axis. At that time, the control signal is not supplied to the α axis excitation electrode 405 and the β axis excitation electrode 403 at the left side so as to make them to have an electric potential the same as that of the mirror section 309. Similarly, in order to displace the swinging face to the substrate 501 side centering around the β axis, when a predetermined control signal is supplied to the β axis excitation electrode 403 at the upper side in FIG. 5, the upper side of the β axis swinging face 305 is displaced to the substrate 501 side centering around the β axis. Since the β axis swinging face 305 is connected by the α axis coupling section 307, the displacement of the β axis swinging face 305 causes the mirror section 309 to be displaced in the same direction.

The control signal of a predetermined voltage to be supplied to the excitation electrodes described above is output from the light projection control section 116. The light projection control section 116 determines a voltage of the control signal to be applied to each of the excitation electrodes based on information determined by the actual display region determination section 115. The light projection control section 116 controls supplying of the control signal to the excitation electrodes independently with respect to the α axis and β axis. Consequently, the mirror section 309 of the light projection device 150 can be inclined with respect to the fixing frame 301 at a two-dimensional arbitrary angle. That is, light in one direction emitted from the light source 151 can be reflected in a two-dimensional arbitrary direction by the mirror section 309.

Regarding the control of the mirror section 309 by the control signal, when a frequency of the control signal supplied to the α axis excitation electrode 405 is the same as a characteristic frequency of the mirror section 309 in the α axis rotational direction, the mirror section 309 can be excited by a control signal having a low level voltage. Similarly, regarding the control of the mirror section 309, when a frequency of the control signal supplied to the β axis excitation electrode 403 is the same as a characteristic frequency of the β axis swinging face 305 in the β axis rotational direction, the β axis swinging face 305 can be excited by a control signal having a low level voltage.

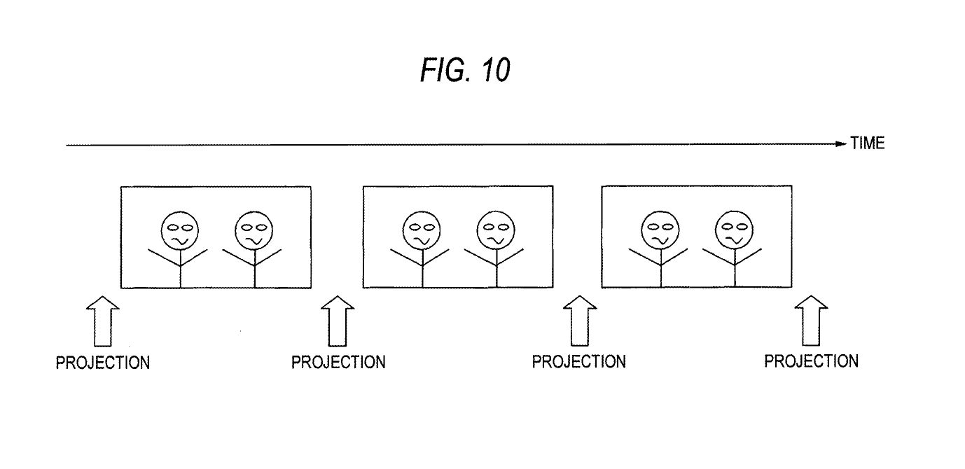

A timing that the light source 151 of the light projection device 150 emits light is a time period between video picture frames at a time when the camera 100 captures a video picture. FIG. 10 is a schematic view showing a time base relationship between each of the video picture frames at a time when the camera 100 captures a video picture and a timing that the light projection device 150 projects the light. As shown in FIG. 10, the light projection device 150 projects the light to a capture region of the camera 100 in a time period between the video picture frames based on a synchronous signal of the camera 100 transmitted from the video picture acquisition section 111. In other words, the light projection device 150 does not project the light at a timing when the camera 100 captures a video picture.

Therefore, by the controlling of the projection of the light in a time period between video picture frames based on the synchronous signal, the light of the light projection device 150 is not captured in a video picture to be displayed on the display 140. As a result of the above, the controlling of the projection of the light in a time period between video picture frames causes the display 140 to display a video picture having a natural color tone irrespective of the projection of light by the light projection device 150.

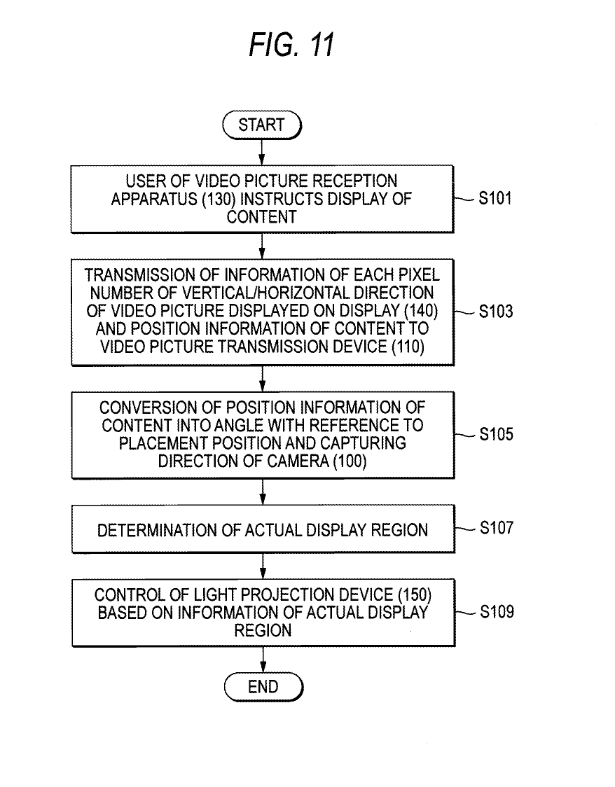

FIG. 11 is a flowchart showing an operation of the video conference system according to the first embodiment. As shown in FIG. 11, a user of the video picture reception device 130 instructs displaying of a content (step S101). Next, the display region acquisition section 134 of the video picture reception device 130 acquires information relating to the number of pixels in each of the vertical and horizontal directions of a video picture to be displayed on the display 140 and position information of the content on two-dimensional coordinate of the video picture, and outputs the information to the display region transmission section 135. The display region transmission section 135 transmits the acquired information to the video picture transmission device 110 (step S103).

Next, the actual display region determination section 115 of the video picture transmission device 110 converts the position information of the content into angle information with reference to the placement position and the capturing direction of the camera 100 on the basis of the capture region information and the content display region information (step S105). Further, the actual display region determination section 115 determines a region obtained by removing the region of the content from the video picture captured by the camera 100 to be an actual display region displayed on the display 140 (step S107). The light projection control section 116 of the video picture transmission device 110 controls the light projection device 150 based on the information about the determined actual display region (step S109).

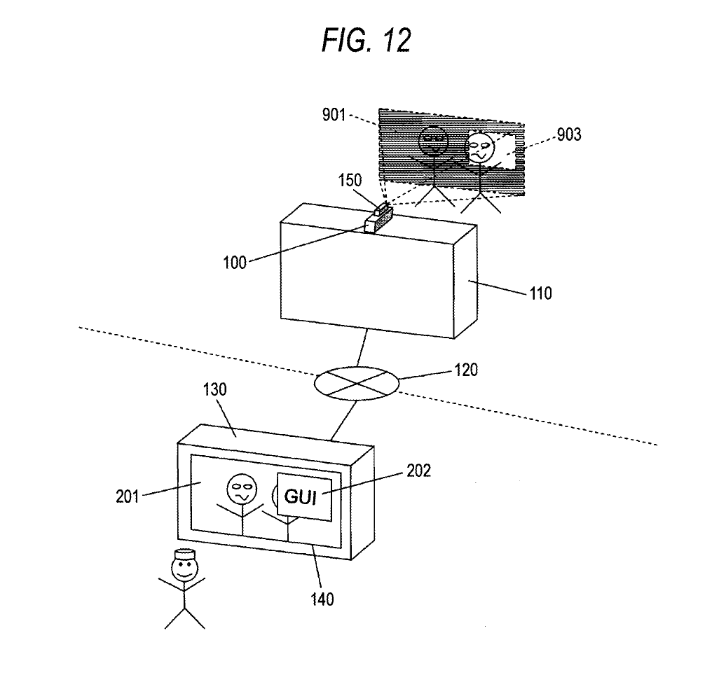

In accordance with the above described embodiment, as shown in FIG. 12, the light projection device 150 projects light to the capture region of the camera 100 corresponding to the region obtained by removing the region of the content 202 from the video picture 201 displayed on the display 140. Therefore, a user of the video picture transmission device 110 can intuitively understand a region 901 which is actually displayed on the display 140 of the video picture reception device 130 in the region captured by the camera 100. In other words, the user can know an region 903 which is captured by the camera 100, but is not actually displayed because of the content 202 which is displayed on the display 140 by being superposed thereon.

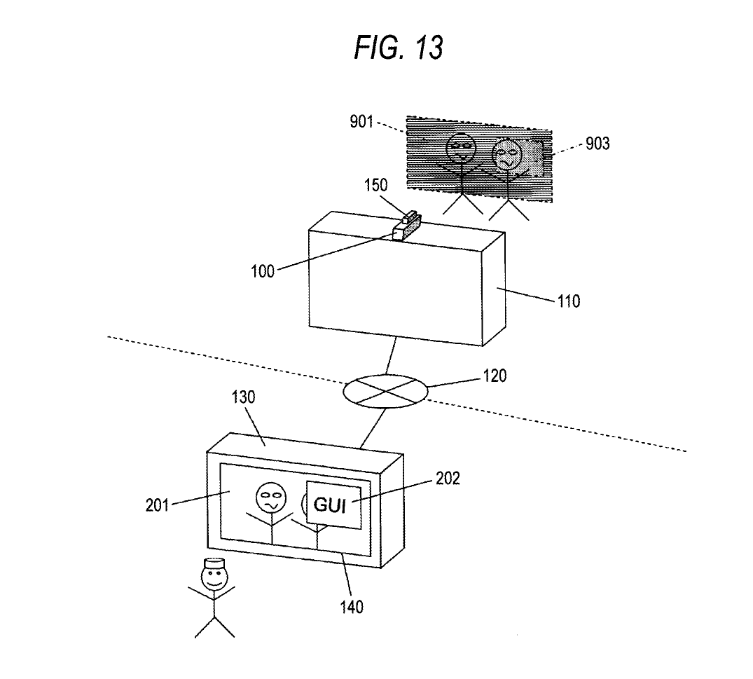

Meanwhile, the light projection device 150 can have light sources having different wavelengths for two colors. In this case, as shown in FIG. 13, the light projection device 150 can project the light of one color to the region 901 which is actually displayed on the display 140 and can the project the light of the other color to the region 903 which is not actually displayed because of the content 202. At that time, since the user in the capture region of the camera 100 can visually observe the light anytime, the user can recognize more accurately the displaying state of the display 140.

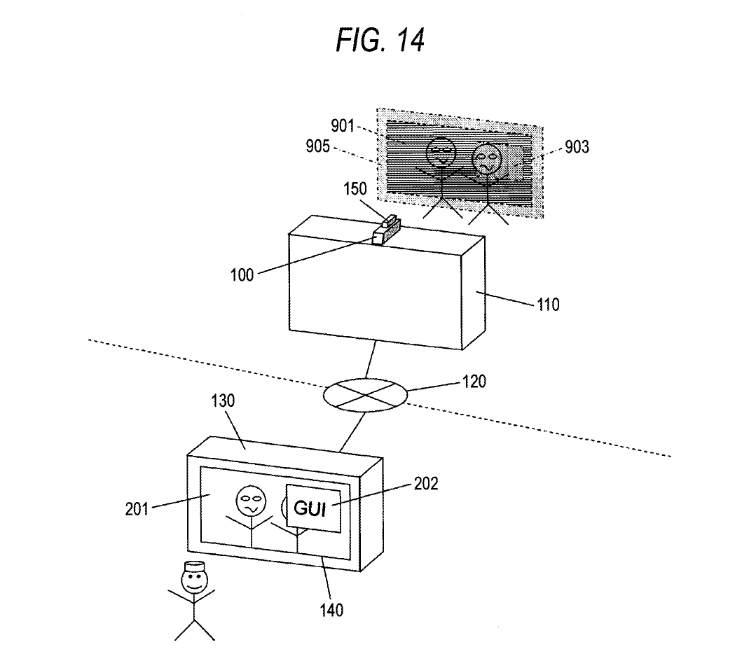

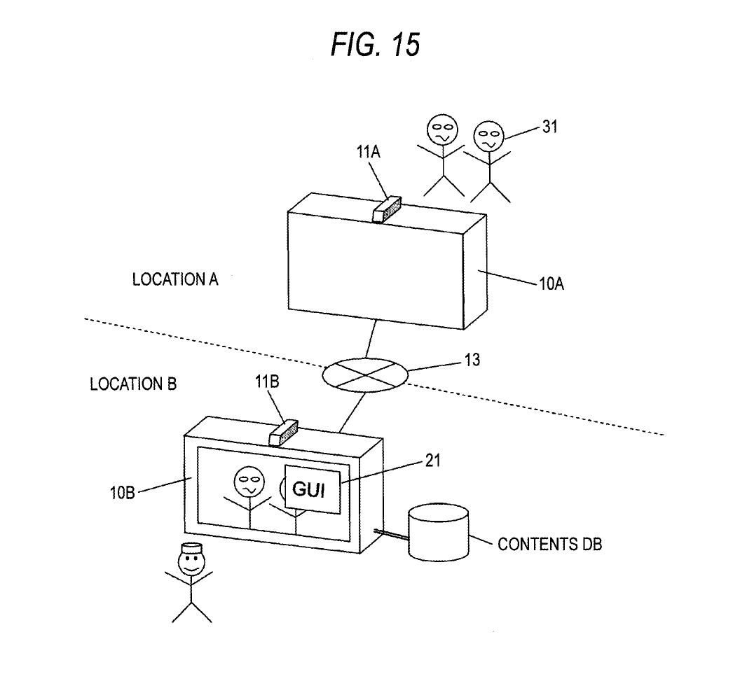

As shown in FIG. 14, the light projection device 150 can project light the same as that is projected to the region 903 to a predetermined region 905 surrounding the outside of the region 901. A certain degree of deviation possibly occurs between the projection range of the light by the light projection device 150 and the capture range of the camera 100. However, in a case where the deviation is in a condition shown in FIG. 14, when the light projected to the region 903 is captured by the camera 100, the user can recognize occurrence of the “deviation”. At that time, by adjusting the region 901 and the region 905, it is possible to accurately match the projection range of the light with the capture range of the camera 100.

In addition, the light projection device 150 can have three or more light sources having different wavelengths for different colors.

The light projection device 150 can increase an amount of light when projecting the light to the outer peripheral portion of the capture region of the camera 100 and can decrease the amount of light when projecting the light to a central portion of the capture region. A user holding a video conference usually positions in the vicinity of a central portion of the capture region of the cameral 100. Therefore, the participant(s) does not feel the light of the light projection device 150 too bright.

The light projection device 150 can increase the amount of light when projecting the light to a corner of a room and can decrease the amount of light when projecting the light to a central portion of the room so as to fit the projection to the size of the room. The light projected to a corner of a room becomes indirect light so that the user does not feel the light of the light projection device 150 too bright.

In a case where the video picture reception device 130 extracts a part of a received video picture captured by the camera 100 and displays it on the display 140 by enlarging, a region which is not displayed on the display 140 can be presented, by the same way, to a user at a video picture transmission device 110 side.

### Second Embodiment

The essence of the embodiment is that a user of a teleconferencing device can intuitively grasp what type of screen configuration is displayed on a display screen of a teleconferencing device at a counterpart location by reproducing and displaying the screen configuration on a display screen of the teleconferencing device at its own location.

In the embodiment, a teleconferencing device is described below as an example of an image display apparatus. In the embodiment, a plurality of teleconferencing devices are respectively placed at a plurality of locations and the placed plurality of teleconferencing devices constitute a video conference system. Each of the teleconferencing devices performs communication of audio data or video picture data via a predetermined communication line. Here, the descriptions are made as regards a case where two teleconferencing devices are placed at respective two locations. However, the invention is not limited to the case.

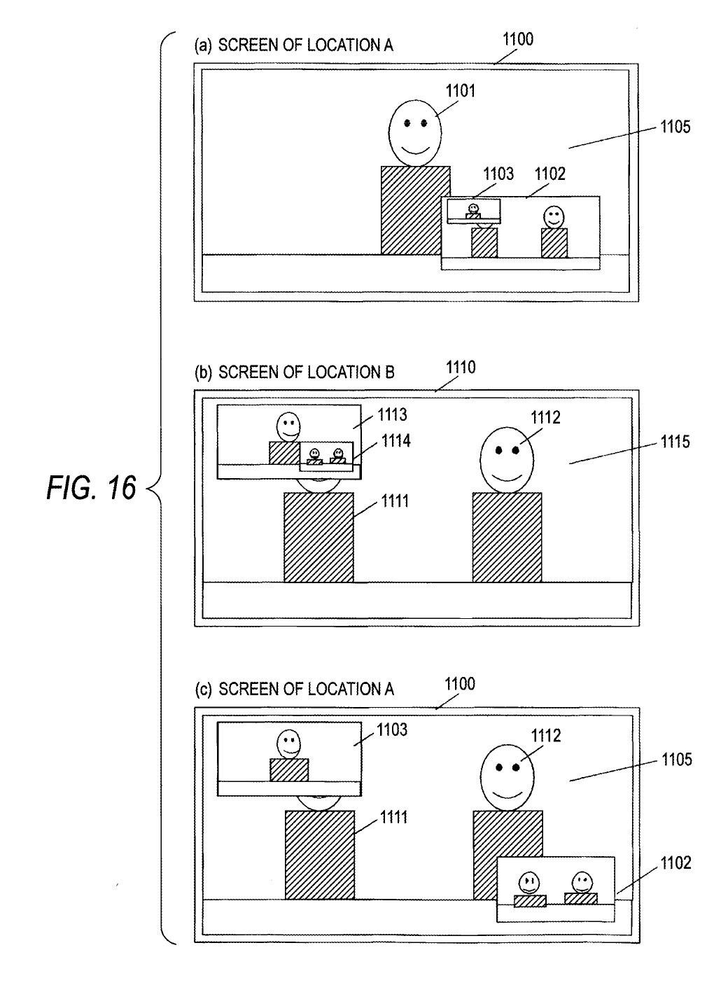

FIG. 16 is a schematic view showing an example of a screen configuration of a display screen of each of the teleconferencing devices placed at the respective locations. The example in FIG. 16 shows the screen configurations at the respective locations A and B when communication is performed by using the teleconferencing devices at the respective two locations A and B. FIG. 16(a) shows the screen configuration of the teleconferencing device placed at the location A and FIG. 16(b) shows the screen configuration of the teleconferencing device placed at the location B.

In the embodiment, it is assumed that conference participants at the location A and conference participants at the location B hold a video conference by using the respective teleconferencing devices. However, the embodiment is not limited to the video conference. For example, another communication can be performed by using video picture data transmitted or received via the teleconferencing devices for a remote lecture, a remote medical treatment or the like. The location A and the location B are not necessarily far away from each other.

A display screen 1100 at the location A shown in FIG. 16(a) has a master screen 1105, a child screen 1102, and a grandchild screen 1103. The child screen 1102 is an example of a subsidiary display region. In the example shown in FIG. 16, the master screen 1105 is a first display region in which video picture data of a person 1101 and the like at the location B captured by a camera at the location B is to be displayed. The child screen 1102 is a second display region in which video picture data displayed in a master screen 1115 of a display screen 1110 at the location B is displayed in a predetermined region in the master screen 1105 by being superposed thereon. The grandchild screen 1103 is a third display region in which video picture data displayed in a child screen 1113 of the display screen 1110 at the location B is displayed in a predetermined region in the child screen 1102 by being superposed thereon.

The display screen 1110 at the location B shown in FIG. 16(b) has, similarly to the above, a master screen 1115, a child screen 1113, and a grandchild screen 1114. The master screen 1115 shown in FIG. 16(b) is a first display region in which video picture data of persons 1111 and 1112 and the like at the location A captured by a camera at the location A is to be displayed. The child screen 1113 is a second display region in which video picture data displayed in the master screen 1105 of the display screen 1100 at the location A is displayed in a predetermined region in the master screen 1115 by being superposed thereon. The grandchild screen 1114 is a third display region in which video picture data displayed in the child screen 1102 of the display screen 1100 at the location A is displayed in a predetermined region in the child screen 1113 by being superposed thereon.

Thus, in FIGS. 16(a) and 16(b), the video picture data of the counterpart person(s) is mutually displayed on the master screens, and the display data which is displayed on the display screen at the counterpart location (hereinafter, also referred to as the counterpart screen display data), is mutually displayed on the child screens. The counterpart screen display data includes display data of a counterpart master screen and display data of a counterpart child screen. Therefore, in FIGS. 16(a) and 16(b), when the display data of the master screen at the counterpart location is displayed on the child screen at the own location, the child screen of the counterpart location is ancillarily displayed to be in a shape of a grandchild screen.

The displays in FIGS. 16(a) and 16(b) are only examples so that each of the video picture data can be displayed in a screen different from the above described screens. For example, a screen configuration at the location A shown in FIG. 16(c) is formed in such a manner that video picture data which is displayed in the master screen 1115 of the display screen 1110 at the location B, is displayed in the master screen 1105. In addition, video picture data of the person 1101 and the like at the location B captured by the camera at the location B is displayed in the child screen 1102. In this case, the child screen 1113 of the display screen 1110 at the location B is displayed in the master screen 1105 by being superposed thereon, the master screen 1115 at the location B being displayed in the master screen 1105. Display data other than the video picture data can be displayed each of the screens.

In FIG. 16(b), for example, the child screen 1113 is displayed in the upper left region of the display screen 1110 on the display screen at the location B, the image of the person 1111 at the location A displayed in the master screen 1115 at the location B is hidden by the child screen 1113. When the person participating in the video conference at the location A watches the child screen 1102 displayed on the display screen 1100 shown in FIG. 16(a), the person can intuitively grasp that the image of the person 1111 is hidden by the child screen and is not displayed in the screen at the location B. Therefore, the person 1111 at the location A can move so as to cause the image itself to be displayed in the screen at the location B if necessary without being orally instructed by a person at the location B. Further, also when an object image to be shown to a counterpart person is displayed, the person at the location A can place the object so as to cause the object image to be surely displayed in the counterpart screen, i.e., the display screen 1110 at the location B while looking at the child screen 1102.

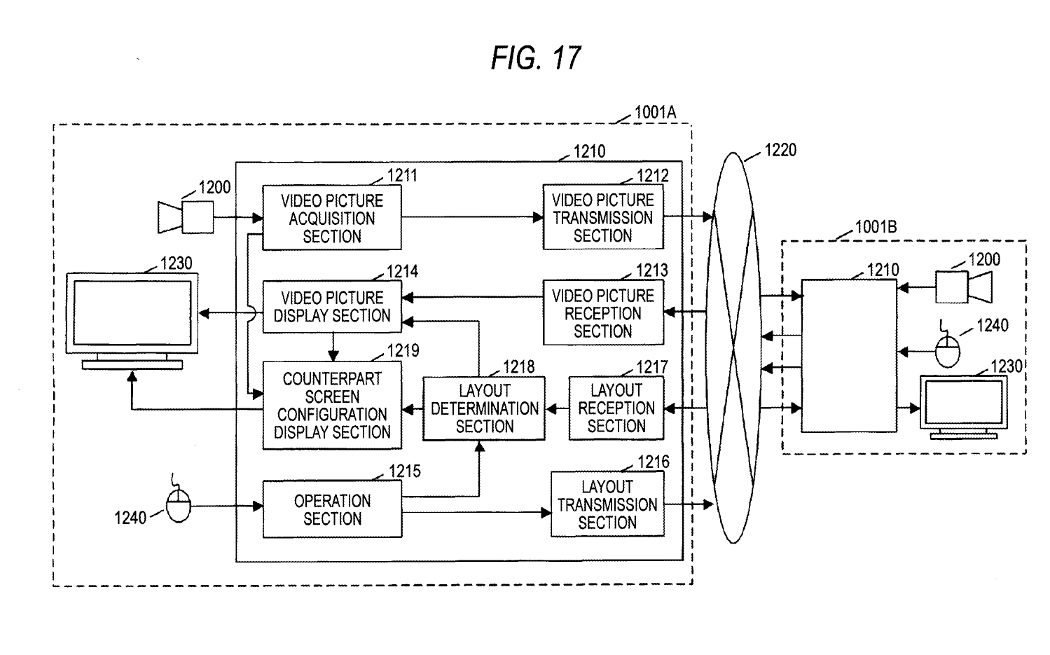

Next, a structure of the teleconferencing device for performing displaying of images as shown in FIG. 16 is described below. FIG. 17 is a block diagram showing an example of a main structure of each of the teleconferencing devices of the embodiment. Here, the description is made by denoting the teleconferencing device placed at the location A by 1001A and the teleconferencing device placed at the location B by 1001B.

Each of the teleconferencing devices 1001A and 1001B shown in FIG. 17 includes a camera 1200 that captures an object such as a person at its own location, a video picture transmission/reception device 1210 that transmits or receives the video picture data of the camera 1200, a display 1230 that displays the received video picture data and the like, and an input device 1240. The video picture transmission/reception device 1210 transmits the video picture data of the camera 1200 to the teleconferencing device at the counterpart location via a network 1220 and receives video picture data from the teleconferencing device at the counterpart location via the network 1220. The display 1230 displays the video picture data and the like received by the video picture transmission/reception device 1210. The input device 1240 is formed of a mouse, a remote controller or the like that instructs a configuration of a display screen to be displayed on the display 1230 by the video picture transmission/reception device 1210 in response to an instruction of a user.

Next, the detail of the video picture transmission/reception device 1210 is described below. To make the explanation understandable, while the teleconferencing device 1001A is described below, the teleconferencing device 1001B which forms a pair together with the teleconferencing device 1001A, has structural components and functions the same as those of the teleconferencing device 1001A. In FIG. 17, regarding the video picture transmission/reception device 1210 of the teleconferencing device 1001B, detailed structural components are omitted.

The video picture transmission/reception device 1210 includes a video picture acquisition section 1211, a video picture transmission section 1212, a video picture reception section 1213, a video picture display section 1214, an operation section 1215, a layout transmission section 1216, a layout reception section 1217, a layout determination section 1218, and a counterpart screen configuration display section 1219.

The video picture acquisition section 1211 acquires video pictures (the video pictures including capture objects such as persons 1111 and 1112, and the like) captured by the camera 1200 as video picture data. The acquired video picture data is, for example, used for video picture data to be displayed in the child screen 1102 of the teleconferencing device 1001A at the location A as the own location. Also, the acquired video picture data is used for video picture to be displayed in the master screen 1115 and the grandchild screen 1114 of the teleconferencing device 1001B at the location B as the counterpart location.

The video picture transmission section 1212 encodes the video picture data acquired by the video picture acquisition section 1211 (hereinafter, the video picture data encoded as the above is referred to as the encoded video picture data), and converts it into data having a data format transmittable to the network 1220. Next, the video picture transmission section 1212 transmits the encoded video picture data to the teleconferencing device 1001B via the network 1220. The encoded video picture data transmitted by the teleconferencing device 1001A is received by the video picture reception section 1213 of the teleconferencing device 1001B.

The video picture reception section 1213 receives the encoded video picture data including a capture object such as the person 1101 or the like transmitted from the teleconferencing device 1001B and converts it into data having a format displayable on the display 1230. The video picture data is, for example, used for video picture data to be displayed in the master screen 1105 and the grandchild screen 1103 of the teleconferencing device 1001A and is used for video picture data to be displayed in the child screen 1113 of the teleconferencing device 1001B. The video picture data received by the teleconferencing device 1001A is the encoded video picture data that is transmitted by the video picture transmission section 1212 of the teleconferencing device 1001B. The video picture reception section 1213 can receive display data other than the encoded video picture data.

The layout reception section 1217 receives counterpart screen configuration information which is transmitted from the teleconferencing device 1001B via the network 1220. The counterpart screen configuration information indicates the screen configuration information for configuring each of the screens such as the master screen 1115, the child screen 113 and the like on the display screen 1110 of the teleconferencing device placed at the location B as the counterpart location. The detail of the counterpart screen configuration information will be described later. Meanwhile, the counterpart screen configuration information received by the teleconferencing device 1001A is own screen configuration information transmitted by the layout transmission section 1216 of the teleconferencing device 1001B.

The operation section 1215 acquires information for designating whether or not the video display section 1214 displays the child screen 1102 via the input device 1240 in response to an instruction of the user of the teleconferencing device 1001A. Alternatively, the operation section 1215 similarly acquires information for designating the position of the child screen 1102 with respect to the display screen 1100. The above designation information is, for example, pattern selection information for selecting one of a plurality of predetermined patterns stored in a storage section (not shown) of the teleconferencing device 1001A. In a case where the child screen 1102 is in a rectangular shape, the information is coordinate information for designating an upper left region or a lower right region. Meanwhile, each of the screens such as the master screen, the child screen and the like is not necessarily in a rectangular shape, but can be in a circular shape or any other shape.

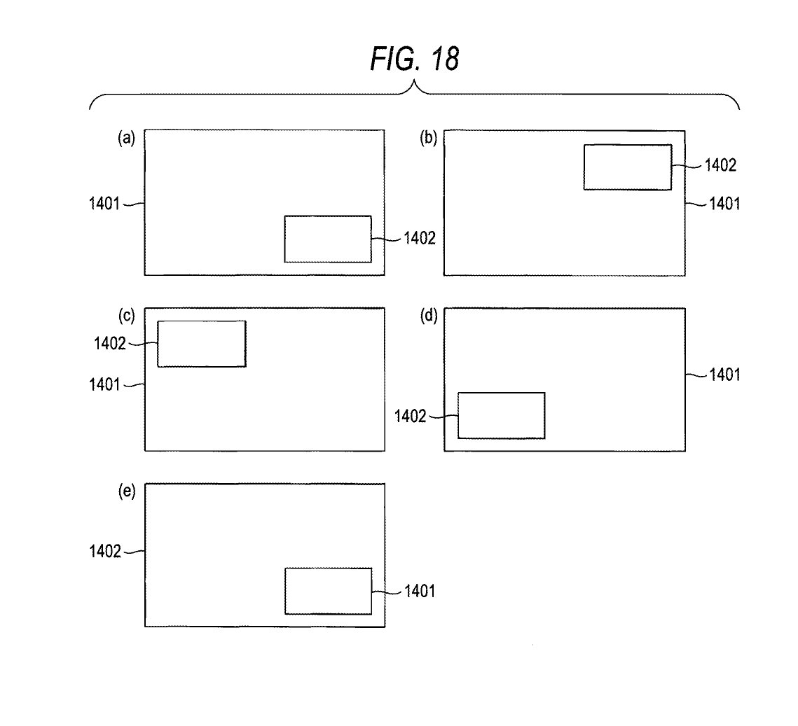

FIG. 18 shows an example of the pattern selection information for selecting the designation information. As shown in FIG. 18, the pattern selection information is adapted to display the child screen 1102, in which first display data 1401 is displayed, in a display region, by being superposed thereon, in the master screen 1105 in which second display data 1402 is displayed. The specific display region is, for example, a lower right portion (FIG. 18(a)), an upper right portion (FIG. 18(b)), an upper left portion (FIG. 18(c)), a lower left portion (FIG. 18(d)) or the like. In an example shown in FIG. 18(e), display contents are switched with each other in contrast to the cases shown in FIGS. 18(a) to 18 (d). In this case, the child screen 1102 in which the first display data 1401 is displayed can be set to a lower right portion or the like in the master screen 1105 in which the second display data 1402 is displayed. The selection of which display mode is to use is determined by the operation section 1215 via the input device 1240.

The operation section 1215 can acquire information for designating which one of the master screen 1105 and the child screen 1102 is to use for displaying the counter screen display data, via the input device 1240 in response to an instruction of the user of the teleconferencing device 1001A.

Further, the operation section 1215 generates the own screen configuration information based on the above information. The own screen configuration information is screen configuration information adapted to configure each of the master screen 1105, the child screen 1102 and the like on the display screen 1100 of the teleconferencing device placed at the location A as the own location. The detail of the own screen configuration information will be described later.

The layout determination section 1218 determines a reproduction region that is adapted to reproduce and display the counterpart screen display data to be display on the display screen at the own location based on the counterpart screen configuration information from the layout reception section 1217 and the own screen configuration information from the operation section 1215. The reproduction region is set to the child screen 1102 of the display screen 1100 or an inner part of the master screen 1105. For example, in a case where the counterpart screen display data is displayed in the child screen 1102, a predetermined region in the child screen 1102 is made to be the reproduction region, and further, the grandchild screen 1103 is ancillarily arranged in a predetermined region of the child screen 1102 in a superposing manner (for example, see FIG. 16(a)). In addition, in a case where the counterpart screen display data is displayed in the master screen 1105, a predetermined region in the master screen 1105 is made to be the reproduction region, and further, the grandchild screen 1103 is ancillarily arranged in a predetermined region of the master screen 1105 in a superposing manner (for example, see FIG. 16(c)).

The layout transmission section 1216 transmits the own screen configuration information from the operation section 1215 to the teleconferencing device 1001B via the network 1220. The layout transmission section 1216 can transmit the own screen configuration information at a timing of displaying the child screen 1102 on the display screen in response to, for example, an instruction of the input device 1240. Meanwhile, the own screen configuration information transmitted by the teleconferencing device 1001A is received by the layout reception section 1217 of the teleconferencing device 1001B as the counterpart screen configuration information.

The video picture display section 1214 displays data other than the counterpart screen display data in the master screen 1105 or the like. For example, the video picture display section 1214 displays video picture data including capture objects such as a person 1101 and the like from the video picture reception section 1213. In addition, in a case where the counterpart screen configuration display section 1219 performs displaying by using the video picture data received by the video picture reception section 1213, the video picture display section 1214 relays the video picture data.

The counterpart screen configuration display section 1219 displays the counterpart screen display data in the child screen 1102 or the like based on the display position determined by the layout determination section 1218. For example, the counterpart screen configuration display section 1219 displays the video picture data including the capture objects such as the person 1101 and the like from the video picture display section 1214 and the video picture data including the capture objects such as persons 1111 and 1112 and the like from the video picture acquisition section 1211 in the child screen 1102.

Next, the detail of the own screen configuration information is described below. Here, the descriptions are made as regards a case where the display screen 1100 of the teleconferencing device 1001A at the own location has the master screen 1105 and the child screen 1102.

The own screen configuration information generated by the operation section 1215 includes first own screen configuration information for displaying the master screen 1105 and second own screen configuration information for displaying the child screen 1102. The own screen configuration information can include display position information of the master screen 1105 with respect to the display screen 1100, display position information of the child screen 1102 with respect to the display screen 1100, and resolution information of the display screen 1100 in the teleconferencing device 1001A. The resolution information is adapted to indicate a resolution by using, for example, pixel as a unit. Further, the own screen configuration information can include information indicating as to what sequence number the master screen 1105 or the child screen 1102 is displayed on the display screen 1100 from the front side of the screen (display sequence number information).

To be specific, in a case where the own screen configuration information includes the display sequence number information, information of (x1, y1, x1′, y1′, N1) is generated as the first own screen configuration information and information of (x2, y2, x2′, y2′, N2) is generated as the second own screen configuration information. Here, “x1” and “y1” indicate an upper left coordinate of a rectangular shape of the master screen 1105. “x1′” and “y1′” indicate a lower right coordinate of the rectangular shape of the master screen 1105. “x2” and “y2” indicate an upper left coordinate of a rectangular shape of the child screen 1102. “x2′” and “y2′” indicate a lower right coordinate of the rectangular shape of the child screen 1102. “N1” and “N2” are values of indicating respective display sequence numbers of the master screen 1105 and the child screen 1102. The lager the value is, the nearer the screen is displayed to the front side of the display screen 1100. While a description regarding the resolution information is omitted in the above, the resolution information is not necessary when the layout determination section 1218 determines the display position or the like of each screen. However, it is necessary when the layout transmission section 1216 transmits the own screen configuration information to the teleconferencing device at the counterpart location.

Next, the detail of the counterpart screen configuration information is described below. Here, the descriptions are made as regards a case where the display screen 1110 of the teleconferencing device 1001B at the counterpart location has the master screen 1105 and the child screen 1113.

The counterpart screen configuration information received by the layout reception section 1217 includes first counterpart screen configuration information which is used by the teleconferencing device 1001B to display the master screen 1115, and second counterpart screen configuration information which is used by the teleconferencing device 1001B to display the child screen 1113. The counterpart screen configuration information includes display position information of the master screen 1115 with respect to the display screen 1110, display position information of the child screen 1113 with respect to the display screen 1110 and resolution information of the display screen 1110 for the teleconferencing device 1001B. Further, the counterpart screen configuration information includes information indicating as to what sequence number the master screen 1115 or the child screen 1113 is displayed on the display screen 1110 from the front side of the screen (display sequence number information).

To be specific, in a case where the counterpart screen configuration information includes the display sequence number information, information of (x3, y3, x3′, y3′, N3) is generated as the first counterpart screen configuration information, information of (x4, y4, x4′, y4′, N4) is generated as the second counterpart screen configuration information, and (X, Y) as the resolution information. Here, “x3” and “y3” indicate an upper left coordinate of a rectangular shape of the master screen 1115. “x3′” and “y3′” indicate a lower right coordinate of the rectangular shape of the master screen 1115. “x4” and “y4” indicate an upper left coordinate of a rectangular shape of the child screen 1113. “x4′” and “y4′” indicate a lower right coordinate of the rectangular shape of the child screen 1113. “N3” and “N4” are values of indicating respective display sequence numbers of the master screen 1113 and the child screen 1115. The lager the value is, the nearer the screen is displayed to the front side of the display screen 1110. “X” indicates the resolution in the horizontal direction in FIG. 16 and the like. “Y” indicates the resolution in the vertical direction in FIG. 16 and the like.

The own screen configuration information and the counterpart screen configuration information are basically the same. While, in the above, the case of using the upper left coordinate and lower right coordinate of the rectangular shape is shown, coordinate information of another portion can be used.

Next, a method of determining the screen configuration of the display screen by the layout determination section 1218 is described below.

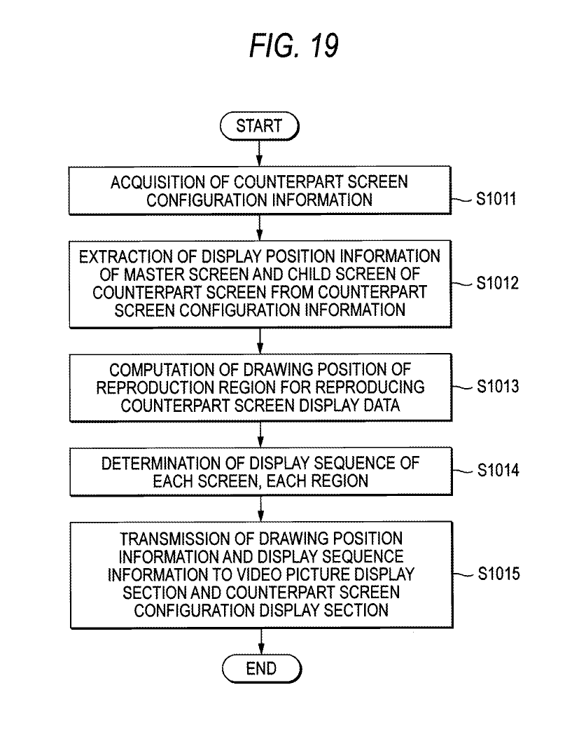

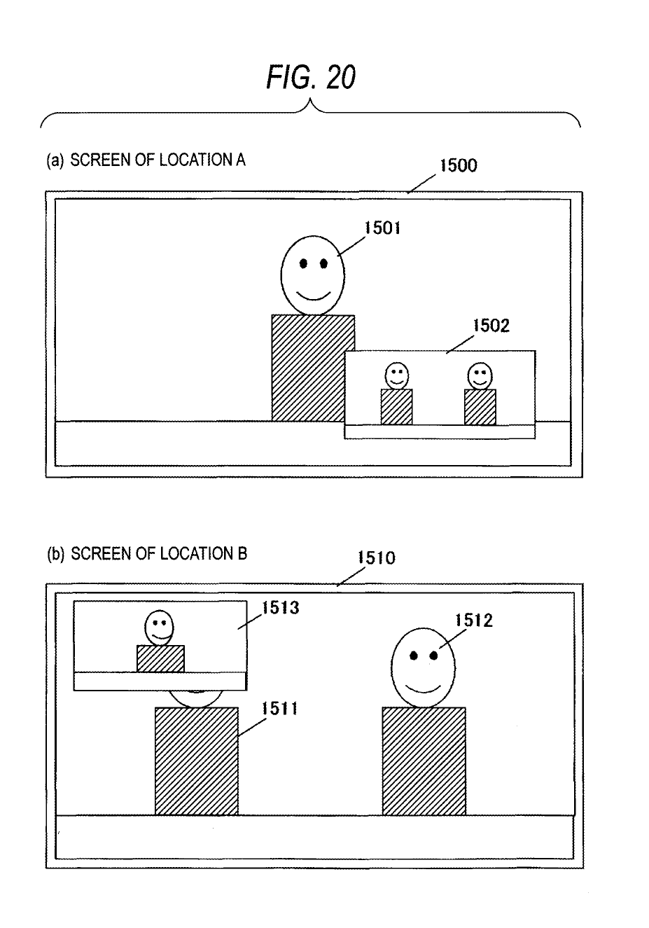

FIG. 19 is a flowchart showing an example of an operation at a time when the layout determination section 1218 determines the screen configuration of the display screen. Here, the display position of each screen, the position of the reproduction region and the display sequence number and the like are determined. In FIG. 19, it is assumed that the display position of each screen is determined based on the coordinate information. To ease the explanation, the teleconferencing device at the own location is denoted by 1001A and the teleconferencing device at the counterpart location is denoted by 1001B. Here, it is assumed that the counterpart screen display data is displayed in the child screen 1102.

First, the layout determination section 1218 acquires the counterpart screen configuration information from the layout reception section 1217 (step S1011).

Next, the layout determination section 1218 obtains the display position information of the master screen 1115, the display position information of the child screen 1113 and the resolution information of the display screen 1110 included in the acquired counterpart screen configuration information (S1012).

Next, the layout determination section 1218 acquires the first own screen configuration information and the second own screen configuration information from the operation section 1215, and the first counterpart screen configuration information, the second counterpart screen configuration information and the resolution information of the counterpart screen from the layout reception section 1217. Next, the layout determination section 1218 determines the screen configuration of the display screen 1100 of the teleconferencing device 1001A based on the obtained respective information. At that time, the layout determination section 1218 computes a drawing position of the reproduction region in which the counterpart screen display data is reproduced and displayed (step S1013).

In the next explanation, an example of a method of computing the drawing position of the reproduction region by the layout determination section 1218, is described. The layout determination section 1218 defines a region corresponding to the master screen 1115 of the teleconferencing device 1001B displayed in the display region of the child screen 1102 to be a master screen correspondence region 1115A. Further, the layout determination section 1218 defines a region corresponding to the child screen 1113 of the teleconferencing device 1001B displayed in the display region of the child screen 1102 to be a child screen correspondence region 1113A. These correspondence regions 1115A and 1113A are examples of reproduction display regions indicating a plurality of display regions in the reproduction region. In this case, the layout determination section 1218 generates first correspondence screen configuration information for displaying the master screen correspondence region 1115A, and second correspondence screen configuration information for displaying the child screen correspondence region 1113A. The first correspondence screen configuration information includes display position information of the master screen correspondence region 1115A with respect to the display screen 1100 and information indicating as to what sequence number the master screen correspondence region 1115A is displayed on the display screen 1100 from the front side of the screen (display sequence number information). The second correspondence screen configuration information includes display position information of the child screen correspondence region 1113A with respect to the display screen 1100 and information indicating as to what sequence number the child screen correspondence region 1113A is displayed on the display screen 1100 from the front side of the screen (display sequence number information).

To be specific, information of (x5, y5, x5′, y5′, N5) is generated as the first correspondence screen configuration information, and information of (x6, y6, x6′, y6′, N6) is generated as the second correspondence screen configuration information. Here, “x5” and “y5” indicate an upper left coordinate of a rectangular shape of the master screen correspondence region 1115A. “x5′” and “y5′” indicate a lower right coordinate of the rectangular shape of the master screen correspondence region 1115A. “x6” and “y6” indicate an upper left coordinate of a rectangular shape of the child screen correspondence region 1113A. “x6′” and “y6′” indicate a lower right coordinate of the rectangular shape of the child screen correspondence region 1113A. In consideration of the master screen correspondence region 1115A and the child screen correspondence region 1113A, “N5” and “N6” are values of indicating respective display sequence numbers of the child screen 1102 and the grandchild screen 1103. The lager the value is, the nearer the screen is displayed to the front side of the display screen 1100. Meanwhile, the child screen correspondence region 1113A automatically represents the grandchild screen 1103.

The above described (x5, y5, x5′, y5′, x6, y6, x6′, y6′) can be represented by the following formulas (5) based on the own screen configuration information and the counterpart screen configuration information.

$$\begin{matrix}Mathematical formula 7 & \\ {x}_{5} = {x}_{2} + \frac{( {x}_{2}^{′} - {x}_{2} )}{x} \times {x}_{3} \\ {y}_{5} = {y}_{2} + \frac{( {y}_{2}^{′} - {y}_{2} )}{Y} \times {y}_{3} \\ {x}_{5}^{′} = {x}_{2} + \frac{( {x}_{2}^{′} - {x}_{2} )}{X} \times {x}_{3}^{′} \\ {y}_{5}^{′} = {y}_{2} + \frac{( {y}_{2}^{′} - {y}_{2} )}{Y} \times {y}_{3}^{′} \\ {x}_{6} = {x}_{2} + \frac{( {x}_{2}^{′} - {x}_{2} )}{X} \times {x}_{4} \\ {y}_{6} = {y}_{2} + \frac{( {y}_{2}^{′} - {y}_{2} )}{Y} \times {y}_{4} \\ {x}_{6}^{′} = {x}_{2} + \frac{( {x}_{2}^{′} - {x}_{2} )}{X} \times {x}_{4}^{′} \\ {y}_{6}^{′} = {y}_{2} + \frac{( {y}_{2}^{′} - {y}_{2} )}{Y} \times {y}_{4}^{′} & ( 5 )\end{matrix}$$

Thus, the layout determination section 1218 can determine the positions of the reproduction regions on the display screen 1100.

In a case where the resolutions are different between the teleconferencing device 1001A and the teleconferencing device 1001B, the region of the child screen 1102 and the reproduction region are different therebetween. In the above case, for example, the display screen of the teleconferencing device 1001A is X:Y=16:9, and the display screen of the teleconferencing device 1001B is X:Y=4:3. In this case, a result that a length in the horizontal direction of the reproduction region is shorter than a length in the horizontal direction of the child screen 1102, is obtained based on the formula (5). In display regions at right and left ends to be out of the reproduction region of the child screen 1102, for example, a monochrome black color can be displayed.

Next, the layout determination section 1218 determines the display sequence of the master screen 1105, the master screen correspondence region 111A of the reproduction region and the child screen correspondence region 1113A (step S1014). For example, regarding the determination of the display sequence, “N5” and “N6” are represented by the following formula (6) with the proviso that a maximum in the display sequence information included in the counter screen configuration information (here, N3 and N4) is represented by Nmax.

$$\begin{matrix}Mathematical formula 8 & \\ {N}_{5} = {N}_{2} + \frac{{N}_{3}}{{N}_{max} + 1} \\ {N}_{6} = {N}_{2} + \frac{{N}_{4}}{{N}_{max} + 1} & ( 6 )\end{matrix}$$

The layout determination section 1218 transmits the correspondence screen configuration information of (x5, y5, x5′, y5′, N5), (x6, y6, x6′, y6′, N6) determined as in the above to the counterpart screen configuration display section 1219. Also, the layout determination section 1218 transmits the first own screen configuration information of (x1, y1, x1′, y1′, N1) to the video picture display section 1214 (step S1015).

Each of the counterpart screen configuration display section 1219 and the video picture display section 1214 compares N1, N5 and N6 as the sequences of superposing and performs the displaying such that the screen having the larger value is displayed to be upper on the display screen 1100 (closer to the front side on the screen) in a superposing manner. To be specific, display data of the master screen 1105, the master screen correspondence region 1115A in the child screen 1102 and the child screen correspondence region 1113A corresponding to the grandchild screen 1103 are displayed. Namely, the display sequence is made such that the grandchild screen 1103 having large display sequence information is displayed at the frontmost side.

When the counterpart screen configuration display section 1219 displays the child screen 1102, the master screen correspondence region 1115A is displayed at a position designated by the first correspondence screen configuration information of (x5, y5, x5′, y5′, N5) by shrinking or expanding the region if needed. Similarly as the above, when the counterpart screen configuration display section 1219 displays the child screen 1102, the child screen correspondence region 1113A is displayed at a position designated by the first correspondence screen configuration information of (x6, y6, x6′, y6′, N6) by shrinking or expanding the region if needed.

In the embodiment, by performing the processes shown in FIG. 19, the video picture data (including the child screen) displayed on the display screen of the teleconferencing device at the counterpart location can be displayed on the display screen of the video picture conference apparatus at the own location. The user at its own location can intuitively grasp whether or not the video picture data of the own location displayed on the display screen at the counterpart location is hidden by the child screen. In the embodiment, the screen is configured based on the counterpart screen configuration information as the layout information acquired from the counterpart location side by using the video picture data held at the own location side. Accordingly, the embodiment can be achieved by only a minimum information amount of the counterpart screen configuration information without transmitting or receiving redundant video picture data.

While, in the embodiment, the descriptions are made by using, as the display data, the video picture data mainly captured by the camera, it is possible to use material data such as material video picture data or the like shared between the own location and the counterpart location. The material data is stored in a storage section (not shown). In this case, third counter part screen configuration information of (x7, y7, x7′, y7′, N7) other than the above described first counterpart screen configuration information of (x3, y3, x3′, y3′, N3) and the second counterpart screen configuration information of (x4, y4, x4′, y4′, N4) is prepared. The layout reception section 1217 receives the counterpart screen configuration information including the third counterpart screen configuration information so that the layout determination section 1218 can determine the display position and the display sequence of the material data and can display the material data in the reproduction region. Obviously, the layout determination section 1218 can generate the own screen configuration information including the information about the material data and the layout transmission section 1216 can transmit the information to the teleconferencing device at the counterpart location.

In the embodiment, even in a case where a window for displaying information about the operation and various configurations, or a Graphical User Interface (hereinafter, referred to as the GUI) of the video picture transmission/reception device 1210 is displayed on the display screen, the regions can be similarly displayed. In this case, fourth counterpart screen configuration information of (x8, y8, x8′, y8′, N8) other than the above described first to third counterpart screen configuration information, is prepared. The layout reception section 1217 receives the counterpart screen configuration information including the fourth counterpart screen configuration information so that the layout determination section 1218 can determine the display position and the display sequence of the GUI or the like and can display the GUI or the like in the reproduction region. Obviously, the layout determination section 1218 can generate the own screen configuration information including the information about the GUI or the like and the layout transmission section 1216 can transmit the information to the teleconferencing device at the counterpart location.

Further, in the embodiment, it is possible to display an icon or the like presenting the fact that a window, a GUI or the like is displayed, without displaying video picture data or the like of the own location and the counterpart location in the child screen or the like on the display screen.

Further, regarding items of the above described each counterpart screen configuration information, an item of “V” of information indicating a type of the image displayed in the master screen or the child screen of the teleconferencing device at the counterpart location can be added, and then the information can be represented by, for example, (x3, y3, x3′, y3′, N3, V3). Regarding information indicating the type of the image, for example, a case of the own image is assigned to 1, a case of the counterpart image is assigned to 2, and a case of the material video picture data is assigned to 3. With this, the video picture display section 1214 and the counterpart screen configuration display section 1219 can respectively identify what type of video picture data is displayed on the child screen 1102 or the grandchild screen 1103.

### Third Embodiment

In the embodiment, a teleconferencing device as an example of an image display apparatus is described below. In the embodiment, a plurality of teleconferencing devices are respectively placed at a plurality of locations and the placed plurality of teleconferencing devices constitute a video conference system. Each teleconferencing device performs communication of audio data or video picture data via a predetermined communication line.

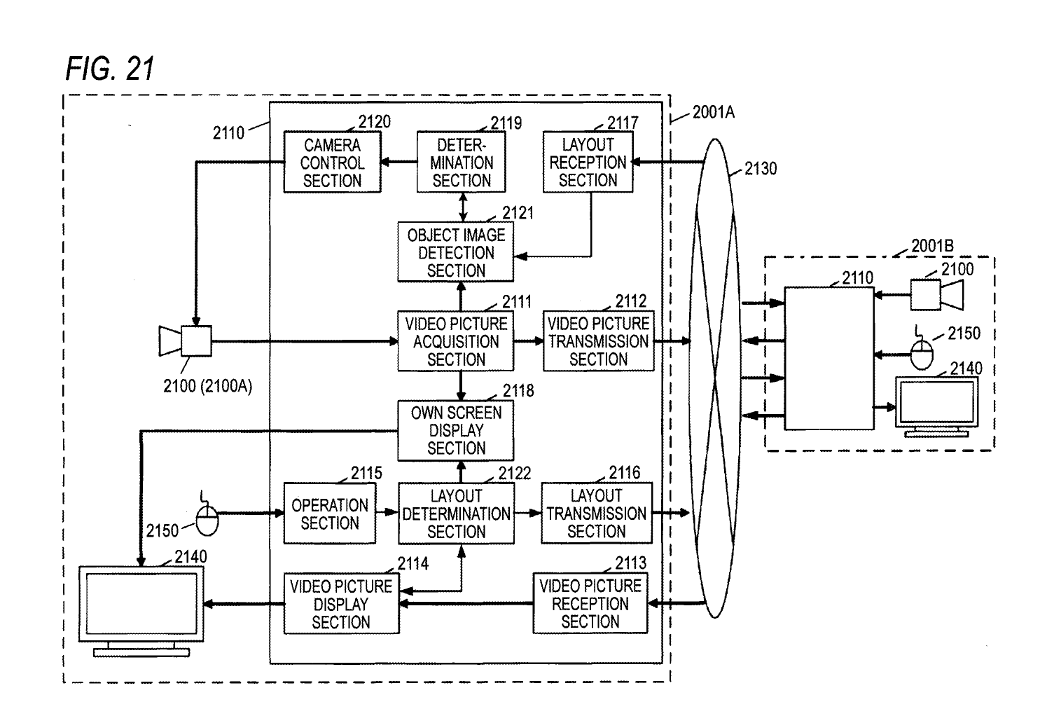

FIG. 21 is a block diagram showing an example of a main structure of each of the teleconferencing devices of the embodiment. Here, the teleconferencing device placed at the location A is denoted by 2001A and the teleconferencing device placed at the location B is denoted by 2001B. The teleconferencing device 2001B is an example of another image display apparatus. In FIG. 21, it is assumed that conference participants at the location A and conference participants at the location B hold a video conference by using the respective teleconferencing devices. However, the structure of FIG. 21 is not limited to the video conference, and, for example, another communication can be performed by using a video picture or audio transmitted or received by the teleconferencing devices. The location A and the location B are not necessarily far away from each other. In addition, here, the descriptions are made as regards a case where two teleconferencing devices are respectively placed at tow locations, but not limited thereto.

Each of the teleconferencing devices 2001A and 2001B shown in FIG. 21 includes a camera 2100, a video picture transmission/reception device 2110, a display 2140, and an input device 2150. The camera 2100 captures an object such as a person at its own location. The video picture transmission/reception device 2110 acquires video picture data of the camera 2100, transmits it to the teleconferencing device at a counterpart location via a network 2130 and receives a video picture from the teleconferencing device at the counterpart location via the network 2130. The display 2140 displays the video picture data and the like received by the video picture transmission/reception device 2110. The input device 2150 has a mouse, a remote controller or the like for performing various operational inputs in response to an instruction of a user.

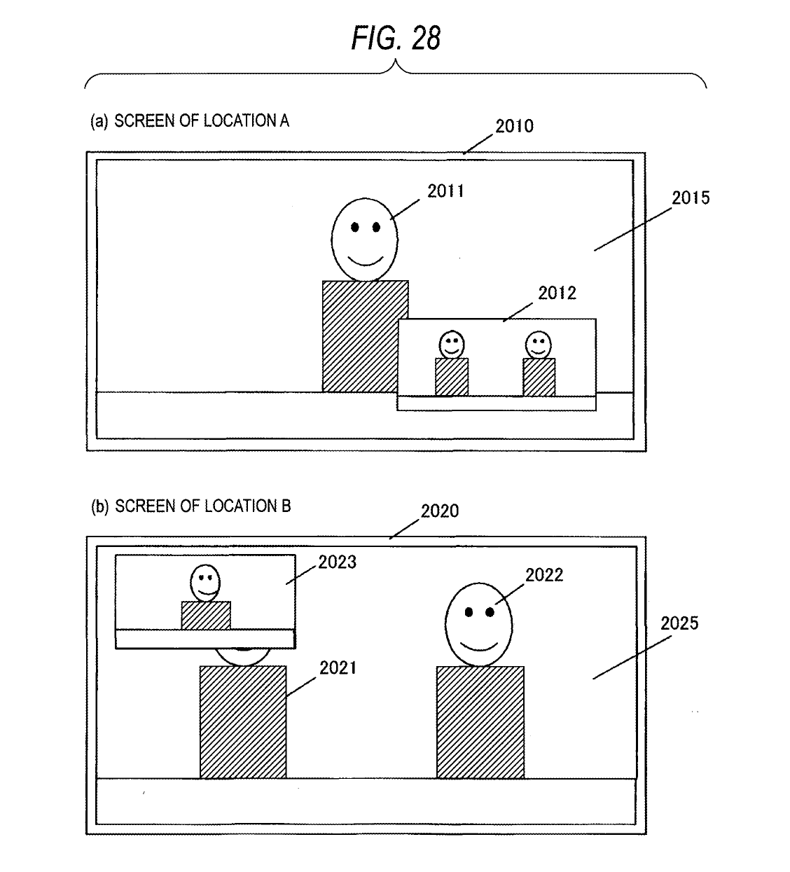

Next, the detail of the video picture transmission/reception device 2110 is described below. To make the explanation understandable, while the teleconferencing device 2001A is described below, the teleconferencing device 2001B which forms a pair together with the teleconferencing device 2001A, has structural components and functions the same as those of the teleconferencing device 2001A. In FIG. 21, regarding the video picture transmission/reception device 2110 of the teleconferencing device 2001B, detailed structural components are omitted. Examples of displaying screens are described with reference to FIG. 28.

The video picture transmission/reception device 2110 includes a video picture acquisition section 2111, a video picture transmission section 2112, a video picture reception section 2113, a video picture display section 2114, an operation section 2115, a layout transmission section 2116, a layout reception section 2117, an own screen display section 2118, a determination section 2119, a camera control section 2120, an object image detection section 2121 and a layout determination section 2122.

The video picture acquisition section 2111 acquires a video picture (the video picture including object images of persons 2021 and 2022 and the like) captured by the camera 2100 as video picture data. The video picture data is, for example, is displayed in a child screen 2012 as a subsidiary display region of the teleconferencing device 2001A at the location A as the own location, and is displayed in a master screen 2025 as a main display region of the teleconferencing device 2001B at the location B as the counterpart location.

The video picture transmission section 2112 encodes the video picture data acquired by the video picture acquisition section 2111 (hereinafter, the video picture data encoded as the above is referred to as the encoded video picture data), and converts it into data having a data format transmittable via the network. Next, the video picture transmission section 2112 transmits the encoded video picture data to the teleconferencing device 2001B via the network 2130. The encoded video picture data transmitted by the teleconferencing device 2001A is received by the video picture reception section 2113 of the teleconferencing device 2001B.

The video picture reception section 2113 receives the encoded video picture data including object images of the person 2011 and the like transmitted from the teleconferencing device 2001B and converts it into data having a format displayable on the display 2140. The video picture data is, for example, displayed in the master screen 2015 of the teleconferencing device 2001A and is displayed in the child screen 2023 of the teleconferencing device 2001B. The video picture data received by the teleconferencing device 2001A is the encoded video picture data that is transmitted by the video picture transmission section 2112 of the teleconferencing device 2001B.

The video picture display section 2114 displays, in the master screen 2015 or the child screen 2012, the video picture data including the object images of the person 2011 and the like from the video picture reception section 2113, sharing data shared with the teleconferencing device 2001B at the counterpart location, or the like. Meanwhile, the video picture display section 2114 displays, in the master screen 2015 or the child screen 2012, data other than the video picture data captured by the camera 2100 at the location A (i.e., other than its own image). The video picture display section 2114 transmits, to the layout determination section 2122, resolution information of the display screen 2010 at a time when displaying the video picture data in the master screen 2015 or the child screen 2012.

The layout reception section 2117 receives counterpart screen configuration information transmitted from the teleconferencing device 2001B via the network 2130. The counterpart configuration information includes screen configuration information for configuring each of screens such as the master screen 2025, the child screen 2023 and the like in the display screen 2020 of the teleconferencing device 2001 placed at the location B as the counterpart location. The detail of the counterpart screen configuration information will be described later. The display screen 2020 is an example of another display screen and the counterpart screen configuration information is an example of another screen configuration information. Meanwhile, the counterpart screen configuration information received by the teleconferencing device 2001A is own screen configuration information transmitted by the layout transmission section 2116 of the teleconferencing device 2001B.

The operation section 2115 acquires, from the input device 2150, information for designating displaying of the child screen 2012 on the own screen display section 2118 or information for designating a position of the child screen 2012 with respect to the display screen 2010 in response to an instruction of a user of the teleconferencing device 2001A. The above designation information is, for example, pattern selection information for selecting one from a predetermined plurality of patterns stored in a storage section (not shown) of the teleconferencing device 2001A. In a case where the child screen 2012 is in a rectangular shape, the designation information is, for example, coordinate information for designating an upper left region or a lower right region thereof. Meanwhile, each of the screens such as the master screen, the child screen and the like is not necessarily in a rectangular shape, but can be in a circular shape or any other shape.

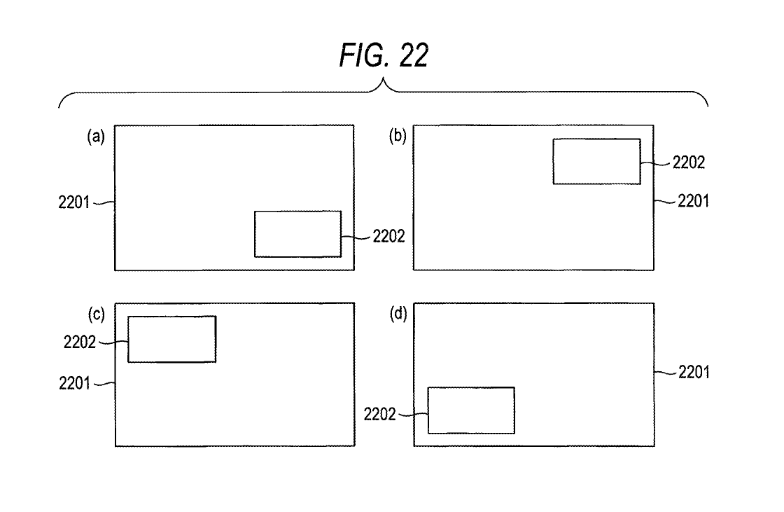

FIG. 22 shows imaging examples of the pattern selection information. As shown in FIG. 22, the pattern selection information is adapted to display the child screen 2012, in which second display data is displayed, in a display region, by being superposed thereon, in the master screen 2015 in which first display data 2201 is displayed. To be specific, the pattern selection information is indicative of a portion such as a lower right portion (FIG. 22(a)), an upper right portion (FIG. 22(b)), an upper left portion (FIG. 22(c)), a lower left portion (FIG. 22(d)) or the like for arrangement of the child screen 2012 to be displayed in the master screen 2015. The selection of which display mode is to use is determined by the operation section 2115 via the input device 2150. The contents displayed in the master screen 2015 and the child screen 2012 include, for example, any of video picture data of the own location acquired by the video picture acquisition section 2111, video picture data of the counterpart location received by the video picture reception section 2113, material data shared by both of the locations, other content data and the like.

The operation section 2115 acquires information for designating whether or not the own image is displayed in response to an instruction of the user of the teleconferencing device 2001A. The operation section 2115 transmits the designation information to the layout determination section 2122.

The layout determination section 2122 generates own screen configuration information based on the designation information from the operation section 2115 and the resolution information of the display screen 2010 from the video picture display section 2114. The own screen configuration information is screen configuration information adapted to configure each of the screens such as the master screen 2015, the child screen 2012 and the like in the display screen 2010 of the teleconferencing device placed at the location A as the own location. The detail of the own screen configuration information will be described later.

The layout transmission section 2116 transmits the own screen configuration information from the layout determination section 2122 to the teleconferencing device 2001B via the network 2130. The layout transmission section 2116 can transmit the own screen configuration information in response to, for example, input of the input device 2150 at a timing of displaying the child screen 2012 on the display screen. Meanwhile, the own screen configuration information transmitted by the teleconferencing device 2001A is received by the layout reception section 2117 of the teleconferencing device 2001B as the counterpart screen configuration information.

The own screen display section 2118 displays the video picture data (i.e., own image), which is acquired by the video picture acquisition section 2111, in the master screen 2015 or the child screen 2012 based on the own screen configuration information from the layout determination section 2122. At that time, the own screen display section 2118 performs shrinking or expanding if needed in accordance with a size of the child screen 2012 designated by the operation section 2115. Meanwhile, the number of the child screens 2012 is not limited to one.

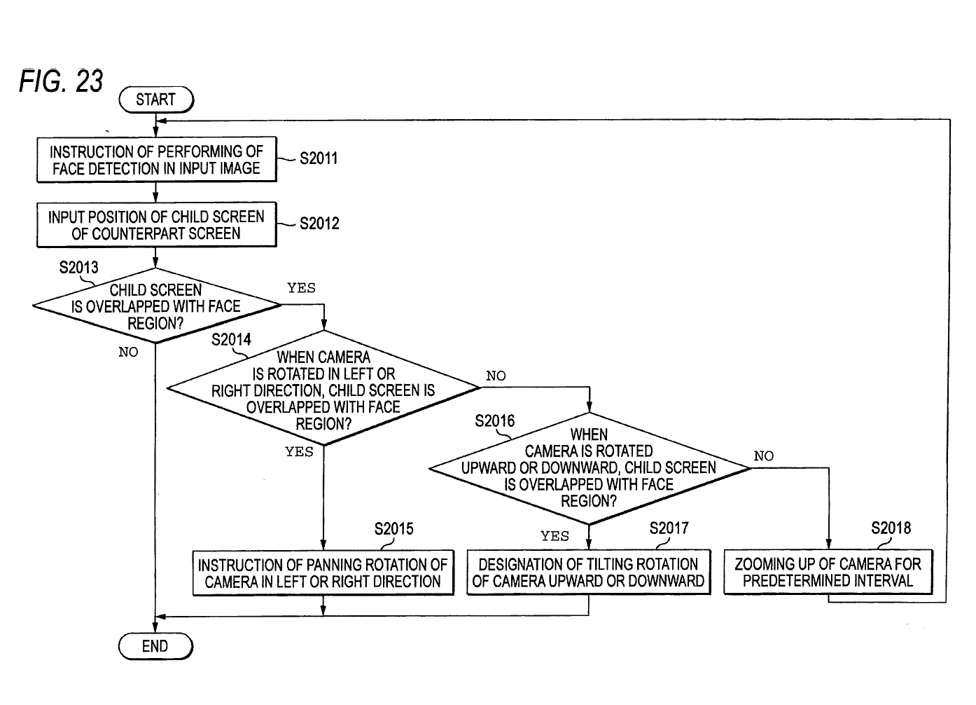

The object image detection section 2121 detects various object images of a face, a person, a material and the like included in the video picture data from the video picture acquisition section 2111. As examples of a method of detecting an object image, there are a background difference method in which a background image not having an object image is captured beforehand, a difference with a current video picture is acquired, and then presence or absence of an object image is inspected, and a face detection method or a person detection method in which an image of a face portion or a person is detected based on extraction of a characteristic of an object image. In addition, the object image detection section 2121 can use, as a method of detecting an object, a moving body detection method for detecting a movement of a detection target in the video picture data. The object image detection section 2121 detects what region in the video picture data the detected object image is positioned. The detected position can be represented by, for example, a positional coordinate of a face region which will be described later with reference to FIG. 23.

The determination section 2119 determines whether or not a child screen is overlapped with a predetermined object image on the display screen at the counterpart location based on the detection result from the object image detection section 2121 and the counterpart screen configuration information from the layout reception section 2117. Next, the determination section 2119 determines a control method (a rotational direction of the camera, a zoom magnification or the like) of the camera 2100 placed on the own location based on the determination result. That is, the determination section 2119 performs designation for controlling a capturing state of the camera 2100 based on the determination as to whether or not the child screen is overlapped with the predetermined object on the display screen at the counterpart location.

The camera control section 2120 generates a camera control command for controlling the camera 2100 based on the control method (the rotational direction of the camera, the zoom magnification or the like) of the camera 2100 obtained by the determination section 2119. The camera control command is a command recognizable by the camera 2100, and is formed of, for example, a character string such as an ASCII code or the like. The camera 2100 is controlled in accordance with the command. Namely, the camera control section 2120 actually controls the capturing state of the camera 2100.

Next, the detail of the own screen configuration information is described below. Here, the descriptions are made as regards a case where the display screen 2010 of the teleconferencing device 2001A as the own apparatus has the child screen 2012. It is assumed that each of the screens is in a rectangular shape.

The own screen configuration information generated by the layout determination section 2122 includes information of an upper left coordinate and a lower right coordinate of a rectangular shape of the child screen 2012, and information of resolutions in the horizontal direction and the vertical direction of the display screen 2010. The resolution information is adapted to indicate a resolution by using, for example, pixel as a unit. Meanwhile, the resolution information is not necessary when the display position of the child screen 2012 is determine, but is necessary when the layout transmission section 2116 transmits the own screen configuration information to the teleconferencing device at the counterpart location. The own screen configuration information can include information relating to respective data to be displayed on the child screen 2012 and the master screen 2015.

Next, the detail of the counterpart screen configuration information is described below. Here, the description is made as regards a case where the display screen 2020 of the teleconferencing device 2001B as the counterpart apparatus has the child screen 2023. It is assumed that each of the screen is in a rectangular shape.

The counterpart screen configuration information received by the layout reception section 2117 includes the counterpart screen configuration information which is used by the teleconferencing device 2001B in order to display the child screen 2023. The counterpart screen configuration information includes information of an upper left coordinate and a lower right coordinate of a rectangular shape, and information of resolutions in the horizontal direction and the vertical direction of the display screen 2020. The another screen configuration information can include information relating to respective data to be displayed in the child screen 2023 and the master screen 2015.

The own screen configuration information and the counterpart screen configuration information are basically the same. While the case where the upper left coordinate and the lower right coordinate of the rectangular shape are used in the above, coordinate information of positions other than the above can be used.

Next, an operation of the determination section 2119 is described below with reference to FIGS. 23 to 27. FIG. 23 is a flowchart showing an example of the operation of the determination section 2119 of the embodiment. In the embodiment, the teleconferencing device at the own location is denoted by 2001A and the teleconferencing device at the counterpart location is denoted by 2001B. In the embodiment, as shown in FIG. 28, the video picture data captured by the camera 2100 at the own location is displayed in the master screen 2025 of the teleconferencing device 2001B and the child screen 2023 is displayed in the master screen 2025 at any portion by being superposed thereon. The descriptions are made as regards a case where the number of participants of the video conference at the own location is two. The object image detection section 2121 performs detection of a face for the detection of the object. Here, the camera at the own location is denoted by 2100A.

First, the determination section 2119 instructs the object image detection section 2121 to perform a predetermined face detection process to be applied to video picture data as an input image from the video picture acquisition section 2111. The face detection process is performed by using a well-known technology (step S2011).

Next, the determination section 2119 acquires the counterpart screen configuration information from the layout reception section 2117. The determination section 2119 obtains the display position information of the child screen 2023 of the teleconferencing device 2001B and the resolution information of the display screen 2010 from the counterpart screen configuration information (step S2012).

Next, the determination section 2119 obtains region information of the face region detected by the object image detection section 2121. In the embodiment, it is assumed that two face regions are detected. The determination section 2119 determines whether or not the child screen 2023 is overlapped with at least one of the two face regions detected by the object image detection section 2121 on the display screen 2020 of the teleconferencing device 2001B (step S2013).

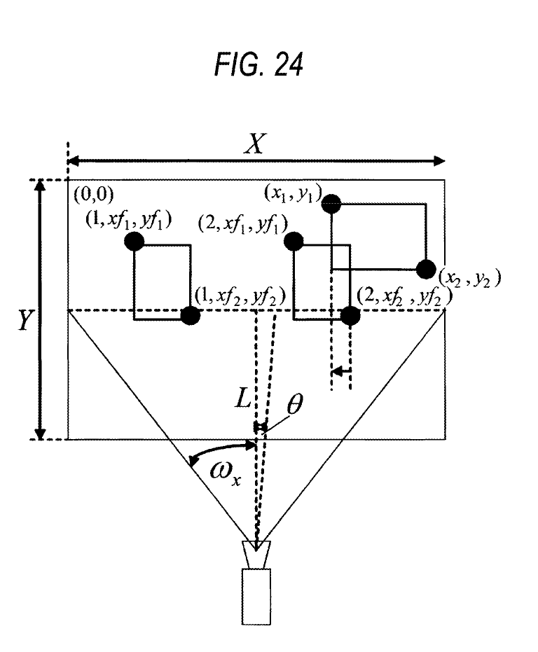

In the descriptions, as shown in FIGS. 24 to 27, it is assumed that the display position information of the child screen 2023 included in the counterpart screen configuration information, includes information of (x1, y1, x2, y2). Here, “x1” and “y1” indicate an upper left coordinate of a rectangular shape of the child screen 2023 on the display screen 2020. “x2” and “y2” indicate a lower right coordinate of the rectangular shape of the child screen 2023 on the display screen 2020.

In addition, a position of the first face region is represented by (1, xf1, yf1), (1, xf2, yf2) and a position of the second face region is represented by (2, xf1, yf1), (2, xf2, yf2). Here, “1” and “2” represent identification information of the face region, “xf1” and “yf1” represent an upper left coordinate of each face region in a display screen 10, and “xf2” and “yf2” represent a lower right coordinate of each face region in a display screen 10. Namely, (1, xf1, yf1) represents the upper left coordinate of the rectangular shape of the first face region, and (1, xf2, yf2) represents the lower right coordinate of the rectangular shape of the first face region. In addition, (2, xf1, yf1) represents the upper left coordinate of the rectangular shape of the second face region, and (2, xf2, yf2) represents the lower right coordinate of the rectangular shape of the second face region. FIGS. 24 to 27 show a case where the first face region is arranged at the left side of the drawing and the second face region is arranged at the right side of the drawing.

In FIGS. 24 to 27, the coordinate can be represented by (identification information of the face region, coordinate information of the face region) for the explanation. For example, (2, xf2) represents “lower right position of the rectangular shape of the second face region×the coordinate of xf2”.

The resolution of the display screen 2020 of the teleconferencing device 2001B is represented by (X, Y). Here, “X” represents the resolution of the display screen 2020 in the horizontal direction and “Y” represents the resolution of the display screen 2020 in the vertical direction.

In step S2013, it is determined that the child screen 2023 is not overlapped with any of the face regions in a case where any of the following formulas (7) to (10) is satisfied.

xf1<x1, and xf2<x1 (7)

x2<xf1, and x2<xf2 (8)

xf1<y1, and yf2<y1 (9)

y2<yf1, and y2<yf2 (10)

In step S2013, in a case where the child screen 2023 of the display screen 2020 is overlapped with any of the face regions, the determination section 2119 determines whether or not the overlapping of the child screen 2023 with each of the face regions can be avoided by the rotation of the camera 2100A in the right or left direction (step S2014). At that time, in a case where any of the following formulas (11) and (12) is satisfied, it is estimated that the child screen 2023 is not out of the display screen 2020 and the child screen 2023 is not overlapped with any of the face regions when the camera 2100A is moved in the right or left direction.

(2,xf2)−(1,xf1)<x1 (11)

(2,xf2)−(1,xf1)<X−x2 (12)

FIG. 24 is a schematic view showing an example of a positional relationship between the child screen 2023 and the face regions in a case where the video picture data captured by the camera 2100A is displayed on the display screen 2020. In a state shown in FIG. 24 which is estimated that the overlapping is not generated based on the formulas (11) and (12) (i.e., in a case of (2, xf2)>x1), any of the face regions is not overlapped with the child screen 2023 when the camera 2100A is rotated in the right direction by an angle indicated by the following formula (13).

$$\begin{matrix}Mathematical formula 9 & \\ θ = {tan}^{- 1} ( tan {ω}_{x} \frac{2 \{ ( 2 , {xf}_{2} ) - {x}_{1} \}}{X} ) & ( 13 )\end{matrix}$$

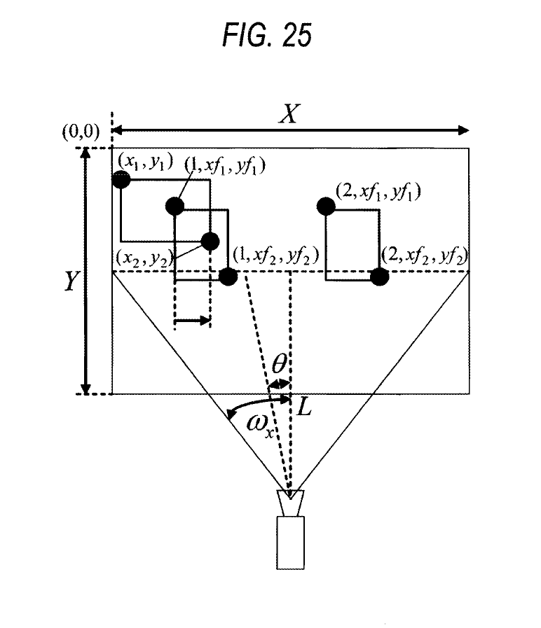

Here, “L” shown in FIG. 24 represents a distance from a position of the camera to a virtual capturing plane. “ωx” represents an angle which is formed between a reference capturing direction and an end portion of a capturing target in the horizontal direction, the reference capturing direction being formed by drawing a perpendicular line from the camera 2100A to the virtual capturing plane. “θ” represents an angle which is formed between the reference capturing direction of the camera 2100A and a rotational angle to be actually rotated. These are the same in FIGS. 25 to 27. “ωy” represents an angle which is formed between the reference capturing direction of the camera 2100A and the end portion of the capturing target in the vertical direction.

FIG. 25 is a schematic view showing an example of a positional relationship between the child screen 2023 and the face regions in a case where the video picture data captured by the camera 2100A is displayed on the display screen 2020. In a state shown in FIG. 25 which is estimated that the overlapping is not generated based on the formulas (11) and (12) (i.e., in a case of (1, xf1)>x2), any of the face regions is not overlapped with the child screen 2023 when the camera 2100 is rotated in the left direction by an angle θ indicated by the following formula (14).

$$\begin{matrix}Mathematical formula 10 & \\ θ = {tan}^{- 1} ( tan {ω}_{x} \frac{2 \{ {x}_{2} - ( 1 , {xf}_{1} ) \}}{X} ) & ( 14 )\end{matrix}$$

In a case where the child screen 2023 is made not to be overlapped with the face regions by rotating the camera 2100 in any of right and left directions as shown in FIGS. 24 and 25, the determination section 2119 transmits determination information to the camera control section 2120 (step S2015). The determination information is adapted to designate panning rotation of the camera 2100A in the left or right direction by the angle θ indicated by the formula (13) or (14).

In a case where it is determined that the child screen 2023 is overlapped with at least one of the face regions even when the camera 2100A is rotated in the left or right direction in step S2014, the determination section 2119 performs the following processes. The determination section 2119 determines whether or not the child screen 2023 is not overlapped with any of the face regions when the camera 2100A is rotated in the vertical direction (step S2016). At that time, in a case where the following formula (15) or (16) is satisfied, the determination section 2119 estimates that the child screen 2023 is not out of the display screen 2020 and the child screen 2023 is not overlapped with any of the face regions even when the camera 2100A is moved in the vertical direction.

(2,yf2)−(1,yf1)<y1 (15)

(2,yf2)−(1,yf1)<Y−y2 (16)

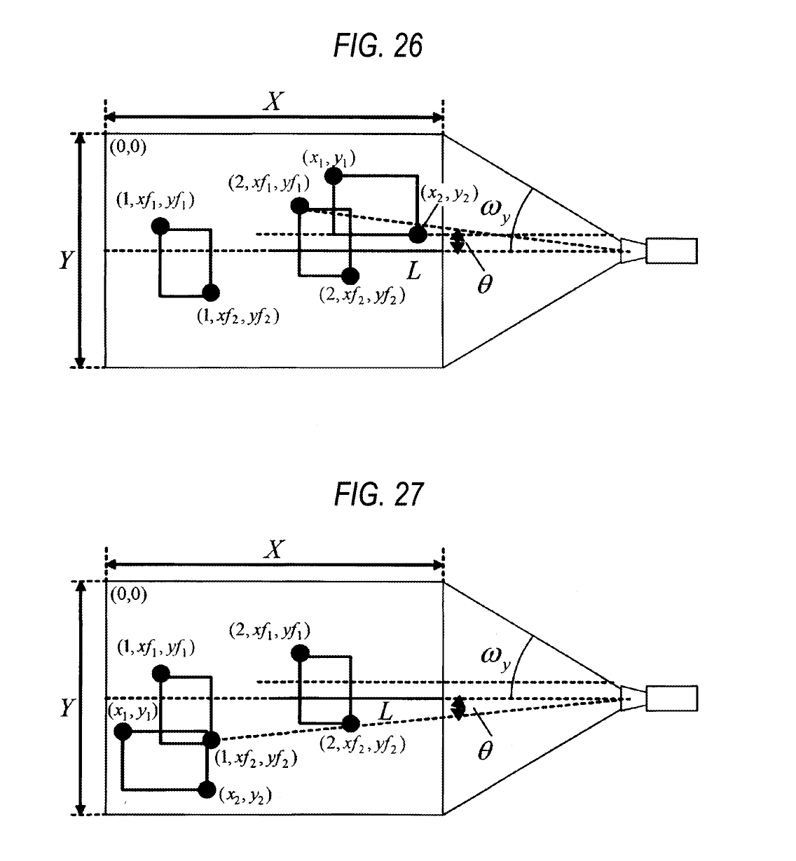

FIG. 26 is a schematic view showing an example of a positional relationship between the child screen 2023 and the face regions in a case where the video picture data captured by the camera 2100A is displayed on the display screen 2020. In a case where the determination section 2119 estimates that the overlapping is not generated based on the formula (15) or (16) and the positional relationship is in the state shown in FIG. 26, a smaller value in (1, yf1) and (2, yf1) is made to be “yfmin”. Next, the determination section 2119 estimates that in a case of yfmin<y2, any of the face regions is not overlapped with the child screen 2023 when the camera 2100A is rotated upward by the angle θ indicated by the following formula (17).

$$\begin{matrix}Mathematical formula 11 & \\ θ = {tan}^{- 1} ( tan {ω}_{y} \frac{2 ( {y}_{2} - {yf}_{min} )}{L} ) & ( 17 )\end{matrix}$$

FIG. 27 is a schematic view showing an example of a positional relationship between the child screen 2023 and the face regions in a case where the video picture data captured by the camera 2100A is displayed on the display screen 2020. In a case where the determination section 2119 estimates that the overlapping is not generated based on the formula (15) or (16) and the positional relationship is in the state shown in FIG. 27, a larger value in (1, yf1) and (2, yf1) is made to be “yfmax”. Next, the determination section 2119 estimates that in a case of yfmax<y1, any of the face regions is not overlapped with the child screen 2023 when the camera 2100 is rotated downward by the angle θ indicated by the following formula (18).

$$\begin{matrix}Mathematical formula 12 & \\ θ = {tan}^{- 1} ( tan {ω}_{y} \frac{2 ( {y}_{t} - {yf}_{max} )}{L} ) & ( 18 )\end{matrix}$$

In a case where the child screen 2023 is made not to be overlapped with the face regions by rotating the camera 2100A upward or downward as shown in FIG. 26 or 27, the determination section 2119 performs the following processes. The determination section 2119 transmits, to the camera control section 2120, determination information that designates tilting rotation of the camera 2100A upward or downward by the angle θ indicated by the formula (17) or (18) (step S2017).

In a case where the child screen 2023 is overlapped with at least one face region even when the camera 2100A is rotated vertically in step S2016, the determination section 2119 performs following processes. The determination section 2119 transmits, to the camera control section 2120, determination information that designates zooming-out by a predetermined amount (i.e., lowering of a capturing magnification) (step S2018). The determination section 2119 returns to step S2011 after executing step S2018. Therefore, the determination section 2119 performs the above determination processes while designating the zooming-out by the predetermined amount until the overlapping between the child screen 2023 and the face regions is eliminated. The determination section 2119 can finish the processes shown in FIG. 23 after a predetermined time period has elapsed from the start of the determination processes before the overlapping between the child screen 2023 and the face regions is eliminated.

Thus, in the embodiment, it is possible to avoid a situation in which display data is hidden by a child screen so as not to be seen due to overlapping between a predetermined object image and the child screen in a display screen of a teleconferencing device placed at a counterpart location.

While a face of a participant of a video conference is made to be an object in FIG. 23, a body itself of the participant can be made to be the object. In the embodiment, material data such as a material video picture or the like shared between an own location or a counterpart location can be made to be an object. In this case, the material data is detected as an object and determination is made so as to prevent the child screen and the material data from being overlapped with each other. In a case where the number of participants of the video conference is two or more, two or more face regions are to be detected, and the camera is controlled so as to prevent the child screen and any of the face regions from being overlapped with each other.

In the embodiment, in a case where it is determined that the child screen 2023 is overlapped with the object image, the description is made by referring to FIG. 23 as follows. That is, first, the camera is rotated in the right or left direction, second, the camera is rotated upward or downward, and third, the zooming-out is performed. However, the sequence is not limited to the above. Further, in the embodiment, in a case where it is determined that the overlapping is generated, the rotation in the right or left direction, the rotation upward or downward and the zooming-out can be independently performed.

This application is based on Japanese Patent Application (JP-2008-296986) filed on Nov. 20, 2008, Japanese Patent Application (JP-2008-316742) filed on Dec. 12, 2008, and Japanese Patent Application (JP-2009-002878) filed on Jan. 8, 2009, the contents of which are incorporated herein by reference.

### INDUSTRIAL APPLICABILITY

The invention is useful for an image display apparatus or the like that allows a user at its own location to recognize a position of a subsidiary display region on a display screen at a counterpart location.

In addition, the invention is useful for a teleconferencing device or the like that presents, to a user of a teleconferencing device which transmits a captured video picture of a camera, an actually displayed region in the captured video picture which is displayed on a display screen of a teleconferencing device that receives the captured video picture.

Further, the invention is useful for a screen display apparatus, a teleconferencing device or the like that can allow a user to grasp what type of content is displayed on a display screen at a counterpart location.

Moreover, the invention is useful for a screen display apparatus, a teleconferencing device or the like that can prevent a child screen from being overlapped with a predetermined object image on a display screen at a counterpart location.

Description of Reference Numerals and Signs

| | |
|---|---|
| 100 | camera |
| 110 | video picture transmission device |
| 150 | light projection device |
| 120 | network |
| 130 | video picture reception device |
| 140 | display |
| 111 | picture acquisition section |
| 112 | video picture transmission section |
| 113 | capture region acquisition section |
| 114 | display region reception section |
| 115 | actual display region determination section |
| 116 | light projection control section |
| 131 | video picture reception section |
| 132 | video picture display processing section |
| 136 | content acquisition section |
| 133 | content display processing section |
| 134 | display region acquisition section |
| 135 | display region transmission section |
| 137 | operation acceptance section |
| 151 | light source |
| 155 | collimator lens |
| 300 | two-dimensional scan mirror |
| 501 | substrate |
| 401 | post section |
| 403 | β axis excitation electrode |
| 405 | α axis excitation electrode |
| 301 | fixing frame |
| 303 | β axis coupling section |
| 305 | β axis swinging face |
| 307 | α axis coupling section |
| 309 | mirror section |
| 1001, 1001A, 1001B | teleconferencing device |
| 1100, 1110 | display screen |
| 1101, 1111, 1112 | person |
| 1102, 1113 | child screen |
| 1103, 1114 | grandchild screen |
| 1105, 1115 | master screen |
| 1200 | camera |
| 1210 | video picture transmission/reception device |
| 1211 | video picture acquisition section |
| 1212 | video picture transmission section |
| 1213 | picture reception section |
| 1214 | video picture display section |
| 1215 | operation section |
| 1216 | layout transmission section |
| 1217 | layout reception section |
| 1218 | layout determination section |
| 1219 | counterpart screen configuration display section |
| 1220 | network |
| 1230 | display |
| 1240 | input device |
| 2001A, 2001B | teleconferencing device |
| 2010, 2020 | display screen |
| 2011, 2021, 2022 | person |
| 2012, 2023 | child screen |
| 2100, 2100A | camera |
| 2110 | video picture transmission/reception device |
| 2111 | video picture acquisition section |
| 2112 | video picture transmission section |
| 2113 | video picture reception section |
| 2114 | video picture display section |
| 2115 | operation section |
| 2116 | layout transmission section |
| 2117 | layout reception section |
| 2118 | own screen display section |
| 2119 | determination section 2119 |
| 2120 | camera control section |
| 2121 | object image detection section |
| 2122 | layout determination section |
| 2140 | display |
| 2150 | input device |

1. An image display apparatus capable of configuring a plurality of display regions on a display screen, comprising:
a reception section that receives, through a communication line, another screen configuration information for configuring a plurality of display regions on a display screen of another image display apparatus; and
a control section that controls to provide a position of a subsidiary display region in the plurality of display regions in the another image display apparatus on the basis of the received another screen configuration information.

2. The image display apparatus according to claim 1, further comprising:
a layout reception section that receives another screen configuration information for configuring a plurality of display regions on a display screen of another image display apparatus;
an own screen configuration setting section that sets own screen configuration information for configuring a display region on a display screen of the image display apparatus;
a layout determination section that determines a position of a reproduction region having a plurality of reproduction display regions which correspond to the plurality of display regions on the display screen of the another image display apparatus, on the display screen of the image display apparatus on the basis of the own screen configuration information and the another screen configuration information; and
a display section that displays, in the reproduction display regions respectively in the reproduction region determined by the layout determination section, respective display data to be displayed in the display regions respectively on the display screen of the another image display apparatus.

3. The image display apparatus according to claim 2, wherein the display section displays display data of a second reproduction display region so as to be superposed on display data of a first reproduction display region.

4. The image display apparatus according to claim 2, wherein the another screen configuration information includes positional relationship information of the plurality of display regions of the another image display apparatus and resolution information of the display screen of the another image display apparatus; and
wherein the reproduction region has the plurality of reproduction display regions having the positional relationship of the plurality of display regions of the another image display apparatus.

5. The image display apparatus according to claim 4, wherein the another screen configuration information includes information indicating a type of display data to be displayed in each display region of the another image display apparatus.

6. The image display apparatus according to claim 5, further comprising:
a video picture data acquisition section that acquires video picture data of an own location where the image display apparatus is placed,
wherein the layout determination section determines a position of a reproduction display region in which the video picture data of the own location displayed in the reproduction region, on the basis of the another screen configuration information and the own screen configuration information; and
wherein the display section displays the video picture data of the own location in the reproduction display region.

7. The image display apparatus according to claim 5, further comprising:
a video picture data reception section that receives, through a communication line, video picture data of another location where the another image display apparatus is placed,
wherein the layout determination section determines a position of a reproduction display region in which the video picture data of the another location is displayed in the reproduction region, on the basis of the another screen configuration information and the own screen configuration information; and
wherein the display section displays the video picture data of the another location in the reproduction display region.

8. The image display apparatus according to claim 5, further comprising:
a storage section that stores material data to be shared with the another display apparatus,
wherein the layout determination section determines a position of a reproduction display region in which the material data is displayed in the reproduction region, on the basis of the another screen configuration information and the own screen configuration information; and
wherein the display section displays the material data in the reproduction display region.

9. A teleconferencing device comprising:
an image display apparatus according claim 2.

10. An image display method in an image display apparatus capable of configuring a plurality of display regions on a display screen, the image display method comprising:
a step of receiving another screen configuration information for configuring a plurality of display regions on a display screen of a second image display apparatus;
a step of setting own screen configuration information for configuring a display region on a display screen of a first image display apparatus;
a step of determining a position of a reproduction region having a plurality of reproduction display regions which correspond to the plurality of display regions on the display screen of the second image display apparatus, on the display screen of the first image display apparatus on the basis of the another screen configuration information and the own screen configuration information; and
a step of displaying, in the reproduction display regions respectively in the reproduction region, respective display data to be displayed in the display regions respectively on the display screen of the second image display apparatus.

11. The image display apparatus according to claim 1, further comprising:
a capture section that captures an object image of an own location where the image display apparatus is placed;
an object image detection section that detects the object image included in video picture data obtained by capturing the capture section;
a layout reception section that receives, through a communication line, another screen configuration information for configuring a plurality of display regions on another display screen as a display screen of the another image display apparatus;
a determination section that determines whether or not the object image included in the video picture data is overlapped with a subsidiary display region which is formed in a main display region in a superposing manner, on the basis of the another screen configuration information and a detection position of the object image, in a case where the video picture data is displayed in the main display region on the another display screen; and
a capturing state control section that controls a capturing state of the capture section based on a determination result of the determination section.

12. The image display apparatus according to claim 11, wherein the another screen configuration information includes display position information of the subsidiary display region and resolution information of the another display screen.

13. The image display apparatus according to claim 12, wherein the determination section determines a rotational angle for rotating the capture section in a horizontal direction based on the another screen configuration information and the detection position of the object image, in a case where the determination section determines that the object image is overlapped with the subsidiary display region in the another display screen; and
wherein the capturing state control section controls to rotate the capture section in the horizontal direction by the rotational angle.

14. The image display apparatus according to claim 12 wherein the determination section determines a rotational angle for rotating the capture section in the vertical direction based on the another screen configuration information and the detection position of the object image, in a case where the determination section determines that the object image is overlapped with the subsidiary display region in the another display screen; and
wherein the capturing state control section controls to rotate the capture section in the vertical direction by the rotational angle.

15. A teleconferencing device comprising:
an image display apparatus according to claim 11.

16. An image display method in an image display apparatus capable of configuring a plurality of display regions on a display screen, the image display method comprising:
a capture step of capturing an object image of an own location where a first image display apparatus is placed;
a detection step of detecting the object image included in video picture data obtained by capturing in the capture step;
a reception step of receiving, through a communication line, another screen configuration information for configuring a plurality of display regions on a display screen of a second image display apparatus;
a determination step of determining whether or not the object image included in the video picture data is overlapped with a subsidiary display region which is formed in a main display region in a superposing manner, on the basis of the another screen configuration information and a detection position of the object image, in a case the video picture data is displayed in the main display region on the display screen of the second image display apparatus; and
a control step of controlling a capturing state of a capture section based on a determination result in the determination step.
